(19) United States
(12) Patent Application Publication
(10) Pub. No.: US 2024/0150210 A1
(43) Pub. Date: May 9, 2024

(54) WASTE TREATMENT APPARATUS AND METHOD

(71) Applicant: SEM ENERGY LIMITED, Potterton (GB)

(72) Inventors: William Alexander Beveridge, Edzell (GB); Leigh Cassidey, Rhynie (GB)

(73) Assignee: SEM ENERGY LIMITED, Potterton (GB)

(21) Appl. No.: 17/775,999

(22) PCT Filed: Aug. 16, 2019
(86) PCT No.: PCT/EP2019/072068

§ 371 Date: May 11, 2022

(30) Foreign Application Priority Data
Aug. 16, 2018 (GB) 1813408.0
Aug. 16, 2018 (WO) PCT/GB2018/000114
Feb. 21, 2019 (GB) 1902356.3
Apr. 25, 2019 (GB) 1905795.9

(51) Int. Cl. C02F 11/12; C02F 11/125; C02F 11/131; C02F 11/147; C02F 11/148; C02F 11/15; C02F 11/18; C02F 103/00; C02F 103/20; C02F 103/32

(52) U.S. Cl. CPC C02F 11/12; C02F 11/125; C02F 11/131; C02F 11/147; C02F 11/148; C02F 11/15; C02F 11/185; C02F 2103/005; C02F 2103/20; C02F 2103/32; C02F 2209/02; C02F 2303/06

(57) ABSTRACT

A method and apparatus for organic waste treatment are disclosed. The method comprises the steps of adding a sorbent to a waste product to form a fluid matrix which may then be subjected to a compressive force to dewater the matrix. Thermal desorption and pasteurisation of the matrix may then be carried out. The sorbent added is draff, which may be obtained as a by-product from various industries, including the distillation of spirits. The apparatus comprises generally a dewatering compressor, but may also include a thermal desorption unit, which may thermally dewater the matrix and pasteurise it.

### FIELD OF THE INVENTION

The present invention relates to apparatus and methods of waste product and the subsequent production of useful by-products. A variety of waste products may be treated by the method and apparatus, and the present disclosure relates especially to the treatment of Anaerobic Digestion digestate (i.e. the waste product of anaerobic digestion), livestock manure slurries, food waste, human effluent or combinations thereof.

### BACKGROUND TO THE INVENTION

Anaerobic Digestion (AD) is a waste treatment process that achieves both pollution control and energy recovery and offers great promise as a food and municipal waste recycling technology. High water content organic waste material (the feed stock), which can comprise a number of waste streams are fed into a ‘digester’. Anaerobic bacteria degrade and stabilise the feed stock via microbial action.

During the process several by-products are produced including biogas (a mixture of methane and carbon dioxide). The produced biogas may be captured for later use; however it is more commonly used to produce electrical energy through a turbine which may be utilised at source or fed back to the national grid. Thus, AD provides a renewable source of energy.

Other by-products of the AD process include ammonia and digested feedstock (digestate). Digestate volumes are ˜80% of feedstock volumes and it is rich in nutrients essential for plant growth (i.e. N, P, K) as these elements are not degraded during the AD process. The amount of ammonia produced and the properties of the digestate vary significantly depending on the composition of the feed stock. Ammonia is inhibitory to biogas production, thus careful selection of salient feed stock constituents is essential, as is homogenisation of the feed stock to ensure consistent biogas yield.

Feedstocks typically comprise biodegradable municipal waste, domestic food waste, animal slurry, arable crops and biodegradable industrial waste (whisky draff or abattoir waste products for example). Feedstock high in lipids and proteins typically produce high biogas yield but can also cause volatile fatty acids formation and high ammonia accumulation (both inhibitory). Feed stocks lower in organic matter but high in fibre typically produce lower biogas yields but more consistent production levels. Thus, a balance must be struck.

Digestate is typically a high-water content (˜>90%) slurry. Although it contains valuable nutrients, untreated it can also contain pathogens that are potentially harmful to the environment, animal and human health. Digestate has typically and historically been used as a bio-fertiliser; spread or injected on arable farmland at salient times of the year instead of synthetic fertilisers.

There are several problems associated with the direct use of digestate as a bio-fertiliser. Firstly, prior to use as a fertiliser it must be pasteurised. In the UK digestate fully certified for use as recycled bio-fertiliser must be PAS110 qualified.

In the UK digestate derived compost or growth media must be PAS100 qualified. Both standards not only require the digestate to be pasteurised, they also require feedstocks to be from segregated sources. PAS110 does not allow the use of municipal sewerage waste in feedstock.

In Scotland, digestate that does not meet the requirements of PAS110 cannot be spread on land without an exemption and proof of biodegradability from SEPA. With the increase in Nitrogen Vulnerable Zones (NVZ's) on arable land, the use of fertilisers and spreading of digestate is severely restricted. Further restrictions exist outside of NVZ's on arable land near to watercourses and water wells. Even PAS110 qualified digestate used in landfill is classed as waste by SEPA rather than a recycled product, thus, it will not count towards national 70% recycling targets. Other disposal methods include incineration which is high energy and wastes the valuable nutrients in the digestate.

It is estimated that ˜1.35 million tonnes of segregated food waste is available in Scotland alone, which could be recycled to produce ˜1.1 million tonnes of PAS110 qualified digestate bio-fertiliser through PAS110 accredited AD plants. However, currently only 207,500 tonnes of food waste is processed in this way, producing ˜172,000 tonnes of qualified digestate, over six sites.

### SUMMARY OF THE INVENTION

According to a first aspect of the present invention there is provided a method of treating a waste product comprising the steps of adding a sorbent to the waste product to form a fluid matrix, the matrix being then subjected to a compressive force to remove a fraction of liquid from the matrix to form a dryer matrix.

The sorbent may be organically derived draff.

The draff may be obtained as a by-product of other processes, such as the production of whisky or other spiritous liquors.

The draff may act as both an absorbent and an adsorbent.

Heat may be applied to the matrix to remove a further fraction of liquid from the matrix and to pasteurise the matrix.

The step of applying heat to the matrix may be done after the application of the compressive force.

The matrix may be flocculated prior to being mechanically compressed.

Ultrasound may be applied to the matrix.

Ultrasound may be applied to the matrix at several discrete points.

Ultrasound may be applied at frequencies of between 20 and 100 khz.

Ultrasound may be applied at frequencies of between 20 and 40 khz.

Ultrasound may be radially focussed around a flow of the matrix.

Ultrasound may be applied after the matrix has been mechanically compressed and prior to it being heated.

Ultrasound may be applied prior to the matrix being mechanically compressed.

Ultrasound may be applied during the matrix being heated.

Nutrients may be added to the matrix.

The nutrients may include one or more from the following group: nitrates, phosphates and potassium.

The temperature of the waste product may be increased prior to the addition of the sorbent.

The temperature may be increased into the range of 20° C. to 100° C.

The temperature may be increased into the range of 80° C. to 100° C.

The sorbent may be added to the waste product at least one hour prior to the application of the compressive force.

According to a second aspect of the present invention there is provided apparatus for treating waste products to which a sorbent has been added to form a matrix, the apparatus comprising a material inlet, a dewatering compressor and a material outlet.

The apparatus may further include flocculating apparatus for flocculating the matrix.

The flocculating apparatus may be provided between the material inlet and the dewatering compressor.

The apparatus may further include a thermal desorption unit.

The thermal desorption unit may be located between the dewatering compressor and the material outlet.

The thermal desorption unit may comprise three sections.

At least one of the three sections may be provided with an auger.

All three sections may be provided with augers.

An inert gas may be injected into the thermal desorption unit.

The inert gas may be injected into a lower portion of at last one of the three sections.

The apparatus may include one or more ultrasound transducers.

The ultrasound transducer(s) may generate frequencies of between 20 and 100 khz.

The ultrasound transducer(s) may generate frequencies of between 20 and 40 khz.

One or more ultrasound transducers may be located between the material inlet and the dewatering compressor.

One or more ultrasound transducers may be located between the dewatering compressor and the thermal desorption unit.

One or more ultrasound transducers may be located on the thermal desorption unit.

The apparatus may further include a heated reaction vessel where the waste product and the sorbent matrix are held prior to entry to the dewatering compressor.

According to a third aspect of the present invention there is provided a compressor for dewatering, comprising an outer body, a fluid inlet, a fluid outlet, and a fluid cavity defined within the outer body, a screw shaft located within the fluid cavity, the screw shaft comprising a central shaft and a helical screw surrounding said central shaft, and a filter surrounding the screw shaft, the compressor further including a micro-solids capture assembly.

The fluid inlet and fluid outlet may comprise pipe or tubing external connections.

The fluid inlet and fluid outlet may comprise flanged external connections.

The micro-solids capture assembly may comprise a capture screen, one or more water jets directed towards and across the capture screen, and a micro-solids entry port.

The capture screen will be substantially planar, and thereby define a capture screen plane.

The one or more water jets may be suspended above the capture screen at a first end.

The micro-solids entry port may be provided adjacent a second end of the capture screen.

The first and second ends may be on distal edges of the capture screen.

The capture screen may be a wire mesh screen.

The capture screen may be a wire wedge screen.

The capture screen may have a filter size of between 100 and 900 μm.

The capture screen may have a filter size of 500 μm.

The micro-solids capture assembly may include spray bar and one or more spray jets. There may be two such jets.

The spray jets may be spade/flat fan jets.

The spray bar may be provided across the capture screen with one or both of the jets extending from the spray bar and being angled toward the capture screen plane.

The jets may be provided at an angle of between 10 and 45° to the capture screen plane.

The jets may be orientated generally towards the second end of the capture screen.

Thus, water may be sprayed across the capture screen, urging micro-solids towards the micro-solids port.

The micro-solids port may be connected to a micro-solids collection assembly.

The micro-solids collection assembly may include a screw conveyor or slurry pump or slurry conveyance device.

The compressor may further include a non-return valve at the fluid outlet.

The non-return valve mechanism may be constructed such that it is housed internally inside the fluid outlet.

The non-return valve mechanism may be hermetically sealed against the inner bore of the fluid outlet.

There may be provided a filter around at least part of the fluid cavity.

The filter may be cylindrical.

The filter may be contra-rotatable with respect to the screw shaft.

The filter may comprise one or more screen sections.

There may be three screen sections.

One or more of the screens may be wire screens.

One or more of the screens may be wedge wire screens.

The screens may comprise an initial screen, an intermediate screen and a terminal screen.

One or more of the screens may be contra-rotatable with respect to the screw shaft.

The screens may have a filter size of between 50 and 500 μm.

The initial screen may have the largest filter size.

The initial screen may have a filter size of between 200 and 300 μm.

The initial screen may have a filter size of 250 μm.

The intermediate screen may have a filter size of between 100 and 200 μm.

The intermediate screen may have a filter size of 175 μm.

The terminal screen may have a filter size of between 50 and 150 μm.

The terminal screen may have a filter size of 100 μm.

The screw conveyor may be an offset screw conveyor.

The screw conveyor may redirect micro-solids into or adjacent the fluid inlet of the compressor.

The central shaft may include a non-uniform section, the non-uniform section having a first outer diameter at a first end and a second outer diameter at a second end, wherein the second diameter is greater than the first diameter.

The central shaft may include a uniform section and a non-uniform section.

The screw shaft may be of any suitable type, including auger-type, but may also be any other suitable type.

The non-uniform section may increase in diameter from the first outer diameter to the second outer diameter in a linear fashion.

The second section may increase in diameter from the first outer diameter to the second outer diameter in a non-linear fashion, such as a step change, a multi-step change, a parabolic change, etc.

The second section may therefore have a generally frusto-conical shape.

The helical screw may have an outer diameter.

The outer diameter of the helical screw over the non-uniform section may remain constant.

This constant outer diameter may be achieved by a decrease in the extent by which the helical screw projects from the non-uniform section of the screw shaft.

The decrease may be complementary to the increase in diameter of the shaft.

The helical screw may have a variable pitch.

The helical screw may have different pitches on the non-uniform and uniform sections.

According to a fourth aspect of the present invention there is provided a compressor for dewatering, comprising an outer body, a fluid inlet, a fluid outlet, and a fluid cavity defined within the outer body, a screw shaft located within the fluid cavity, the screw shaft comprising a central shaft and a helical screw surrounding said central shaft, and a filter surrounding the screw shaft, wherein the central shaft includes a non-uniform section, the non-uniform section having a first outer diameter at a first end and a second outer diameter at a second end, wherein the second diameter is greater than the first diameter.

The compressor of the second aspect may comprise a micro-solids capture assembly. Further optional features of the second aspect may be inferred from optional features listed with respect to the first aspect.

### BRIEF DESCRIPTION OF THE DRAWINGS

Embodiments of the invention will now be described, by way of example only, with reference to the following drawings, in which:

FIG. 1 is an isometric view of a first embodiment apparatus and method according to the various aspects of the present invention;

FIG. 2 is a sectional side elevation of a filtration unit of the apparatus of FIG. 1;

FIG. 3 is a perspective view of a thermal desorption unit of the apparatus of FIG. 1;

FIG. 4 is a part-sectional perspective view of the thermal desorption unit of the apparatus of FIG. 1;

FIG. 5 is a side elevation of the thermal desorption unit of the apparatus of FIG. 1;

FIG. 6 is a part-sectional side elevation of the thermal desorption unit of the apparatus of FIG. 1;

FIG. 7 is a plan view of the apparatus of FIG. 1;

FIG. 8 is a side elevation of the thermal desorption unit of FIG. 7;

FIG. 9 is a side elevation of the hopper/macerator, compressor and thermal desorption unit assembly of the first and second embodiments;

FIG. 10 is a perspective view of a flocculation unit of the apparatus of FIG. 1; and

FIG. 11 is a further perspective view of the apparatus of FIG. 1;

FIG. 12 is a perspective view from a first end of a compressor of the apparatus of FIG. 1;

FIG. 13 is a perspective view from a second end of the compressor of FIG. 12;

FIG. 14 is a part-sectional perspective view of the dewatering compressor of FIG. 12;

FIG. 15 is a part-sectional side elevation of the compressor of FIG. 12;

FIG. 16 is a part-sectional perspective detail view of the micro-solids capture assembly of the compressor of FIG. 12;

FIG. 17 is a further part-sectional perspective detail view of the micro-solids capture assembly of the compressor of FIG. 12;

FIG. 18 is a further part-sectional perspective detail view of the micro-solids capture assembly of the compressor of FIG. 12;

FIG. 19 is a part-sectional side elevation detail view of the micro-solids capture assembly of the compressor of FIG. 12;

FIG. 20 is a further perspective view of the compressor of FIG. 12;

FIG. 21 is a detail perspective view of a capture tray of the compressor of FIG. 12;

FIG. 22 is part-sectional side elevation detail view of the outlet valve in a closed position of the compressor of FIG. 12;

FIG. 23 is part-sectional side elevation detail view of the outlet valve in an open position of the compressor of FIG. 12;

FIG. 24 is a part-sectional perspective view of the dewatering compressor of FIG. 12;

FIG. 25 is a part-sectional side elevation of the intake assembly of the compressor of FIG. 12;

FIG. 26 is a perspective view of a material treatment process train including the compressor of FIG. 12;

FIG. 27 is side elevation an alternative screw compressor profile usable with the compressor of FIG. 12;

FIG. 28 is a schematic representation of a second embodiment of the present invention according to the various aspects of the present invention;

FIG. 29 is a schematic representation of a third embodiment of the present invention according to the various aspects of the present invention;

FIG. 30 is a side elevation of a first generator usable with the apparatus of FIG. 1, 28 or 29;

FIG. 31 is a plan view of a first generator usable with the apparatus of FIG. 1, 28 or 29;

FIG. 32 is a side sectional elevation of a first feed tube usable with the apparatus of FIG. 1, 28 or 29;

FIG. 33 is a plan sectional view of a first generator usable with the apparatus of FIG. 1, 28 or 29;

FIG. 34 is an end elevation of a first feed tube usable with the apparatus of FIG. 1, 28 or 29;

FIGS. 35 to 42 are various detail views of the first generator of FIGS. 30 to 32;

FIG. 43 is a side elevation of a second generator usable with the apparatus of FIG. 1, 28 or 29;

FIG. 44 is a plan view of a second generator usable with the apparatus of FIG. 1, 28 or 29;

FIG. 45 is a sectional side elevation of a second feed tube usable with the apparatus of FIG. 1, 28 or 29;

FIG. 46 is an end elevation of a second generator usable with the apparatus of FIG. 1, 28 or 29;

FIGS. 47 to 50 are various detail views of the second generator of FIGS. 43 to 46;

FIG. 51 is a side elevation of a third generator usable with the apparatus of FIG. 1, 28 or 29;

FIG. 52 is a plan view of a third generator usable with the apparatus of FIG. 1, 28 or 29;

FIG. 53 is a side sectional elevation of a third feed tube usable with the apparatus of FIG. 1, 28 or 29;

FIG. 54 is an end elevation of a third generator usable with the apparatus of FIG. 1, 28 or 29;

FIGS. 55 to 58 are various detail views of the third generator of FIGS. 51 to 54;

FIG. 59 is a side sectional elevation of an assembly comprising a first, second and third generators;

FIG. 60 is a schematic representation of a fourth embodiment of the present invention according to the various aspects of the present invention;

FIG. 61 is a schematic representation of a fifth embodiment of the present invention according to the various aspects of the present invention;

FIG. 62 is a schematic representation of a sixth embodiment of the present invention according to the various aspects of the present invention;

FIG. 63 is a graph showing cumulative sorption of nutrients at room temperature;

FIG. 64 is a table showing cumulative sorption of nutrients at various temperatures; and

FIG. 65 is a graph showing nutrient sorption of nutrients at various temperatures.

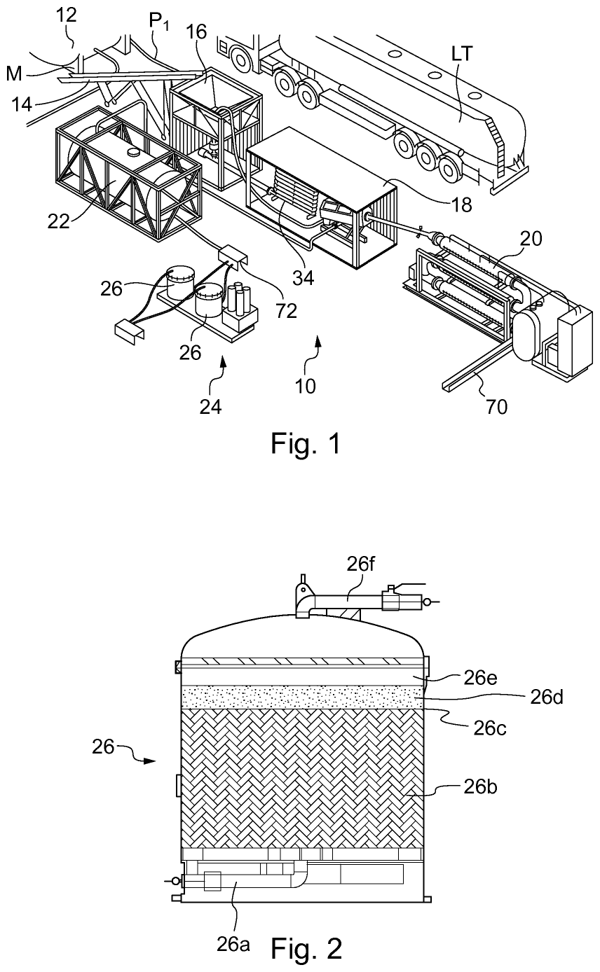

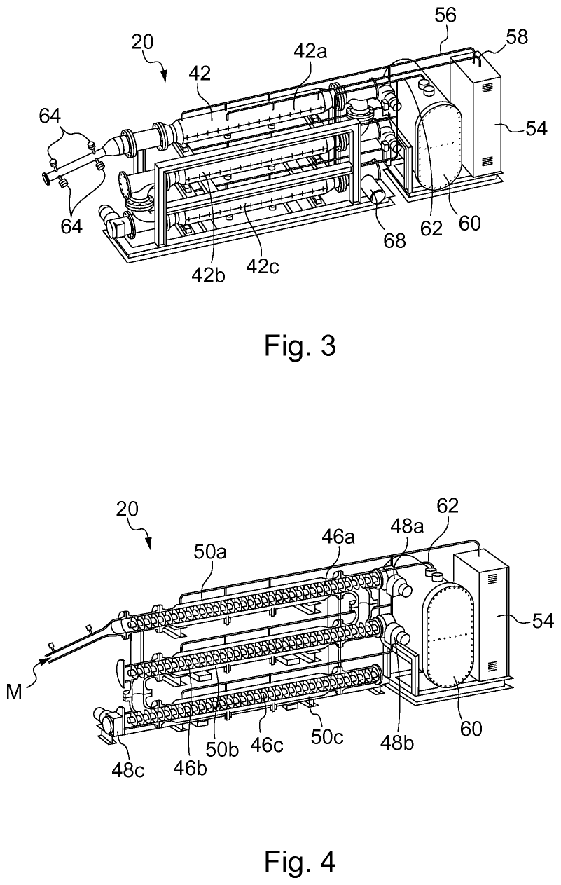

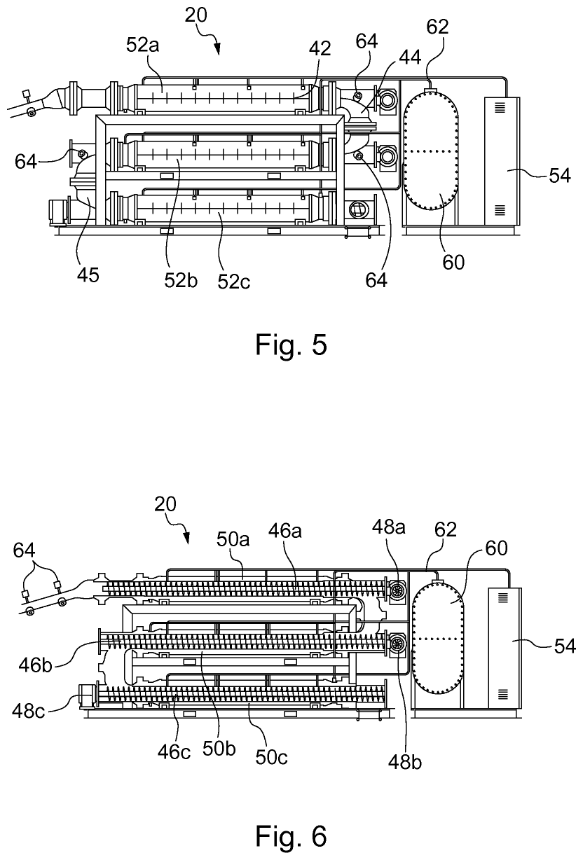

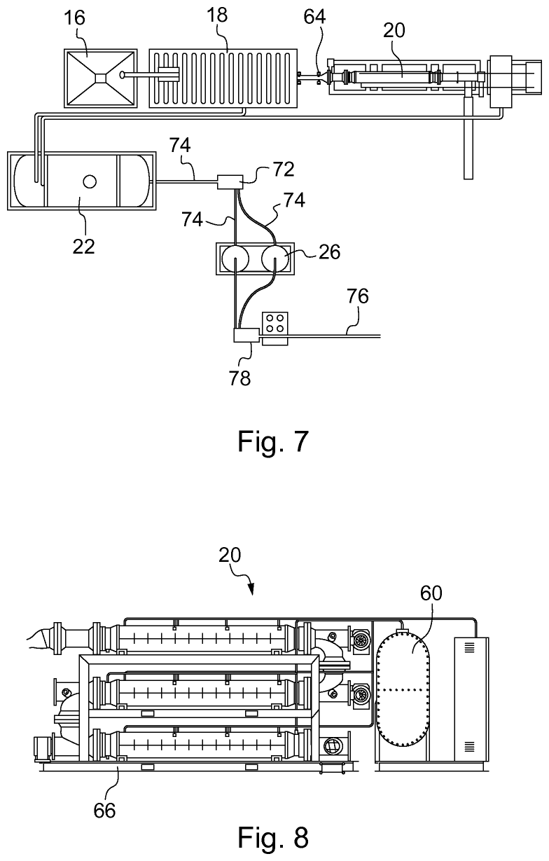

Referring to the drawings and initially to FIG. 1, a first embodiment waste product method and apparatus 10 are depicted. The method and apparatus are being used in the present embodiment to treat agricultural slurry and/or AD digestates, but it will be appreciated by the skilled addressee that this apparatus and method may be used to treat a multitude of waste products and by-products and is not limited to merely agricultural slurry. For example, food waste, human sewage, etc, may be treated.

The apparatus 10 comprises an sorbent/slurry mixing tank 12, a transport conveyor belt 14, a hopper/macerator unit 16, a dewatering compressor unit 18, a thermal desorption unit 20, a spent water tank 22 and two filtration assembly 24, the latter comprising two individual filtration units 26.

Agricultural slurry AS is transported to the apparatus 10 by liquid trailer LT. As an alternative, the slurry or other waste product may be fed directly into the apparatus 10 from a nearby slurry lagoon, tank or something similar.

The slurry AS is combined with a sorbent A and/or reagent R by pumping it into the sorbent tank 12 to form a matrix M. The agricultural slurry AS in the present embodiment will be that typically found in slurry lagoons or pits, and will have an appreciable proportion of water. This water is unusable given the other contaminants present within the slurry AS.

A pipe P1 and a pump (not shown) may be used to transport slurry AS from liquid trailer LT to sorbent tank 12.

Sorbent A in the present embodiment is draff obtained as a by-product of whisky production. It will be appreciated by the skilled addressee that other types of draff, from brewing for example, or indeed other forms of suitable sorbent may be usable in the process. Such an sorbent derived from whisky draff may be found in PCT/GB2008/003308, the contents of which are hereby incorporated by reference.

The draff sorbent A acts as both an absorbent and an adsorbent, generally absorbing water and adsorbing nutrients.

The matrix M is moved from the tank 12 onto the conveyor belt 14. The matrix M is transported along the conveyor belt 14 and deposited into the upper entrance of the hopper/macerator unit 16. Further reagents or dosing chemicals may be added at this point in order to tune the material being outputted by the system.

Hopper/macerator unit 16 includes an inline macerator 28, through which the matrix M is broken up and into the intake of first pump 30. First pump 30 forces the matrix M along hopper exit pipe 32. First pump 30 in the present embodiment is a Progressive Cavity Pump, but the skilled addressee will appreciate that other forms of pumps, especially positive displacement pumps may be used instead.

An in-line flocculation assembly 34 attaches to the hopper exit pipe 32. The in-line flocculation assembly 34 comprises three static mixing spools 34a, 34b, 34c with chemical injection points. The flocculation assembly 34 may serve several purposes:
i. the Matrix may be pH balanced (generally first spool 34a);
ii. Slurry is mixed with biodegradable, environmentally friendly coagulant (generally second spool 34b);
iii. Slurry is mixed with biodegradable, environmentally friendly flocculant (generally third spool 34c);
iv. This system essentially causes all solid matter (down to colloidal solids) to ‘clump’ together and causes the water fraction to partially separate out;
v. Flocculation is optimised and the system continually descaled through the application of upstream radially focused power ultrasonic (US) sound waves. Ultrasound transducers 64 are attached as an upstream radially focussed ‘daisy-chain’, within 2 meters of the flocculation system. The number of transducers at the daisy-chain is typically four, however this number can increase or decrease depending on pipe size. This also serves to:
   1. Enhance flocculation and decrease turbidity/micro-solids (down to colloidal solids) in separated water;
   2. Cause resonance in the structural body of the ironwork ensuring that no scale can build up and that plugs are prevented from forming
      a. Power US frequencies are typically between 20-30 kHz with each transducer typically drawing <150 Watts
      b. Higher US frequencies in the low MHz (1-4) range can also be effective at similar power draws depending on the effluent stream.

The in-line flocculation assembly 34 also includes an elongate coiled pipework 37 which includes the chemical injection points (not shown).

A mechanical compressor 36 receives the matrix M from the flocculation assembly 34 and through mechanical compression removes a portion of the liquid from the matrix M.

The mechanical compressor 36 comprises an outer body 112, a fluid inlet 114, a fluid outlet 116, and a fluid cavity 118 defined within the outer body 12, a screw shaft 20 located within the fluid cavity 118, the screw shaft 120 comprising a central shaft 122 and a helical screw 124 surrounding the central shaft 122, and a cylindrical filter 126 surrounding the screw shaft 120, the compressor 36 further including a micro-solids capture assembly 128.

It will be noted that the compressor 36 is generally orientated at an angle to the horizontal, with the fluid inlet 114 being lower than the fluid outlet 116.

The micro-solids capture assembly 128 comprises a capture screen 130, and two water jets 132 directed towards and across the capture screen 130, and a micro-solids entry port 134.

The capture screen 130 is substantially planar, and thereby defines a capture screen plane 136.

A capture tray 138 is provided at the lowermost portion of the body 112 and generally beneath the fluid cavity 118 and screw shaft 120. The capture tray 138 is a generally shallow rectangular frustum shape comprising two greater length angled side walls 140 running generally parallel to an axis X-X of the compressor 110, and a shorter length angled side wall 142 located adjacent the fluid outlet 116. The micro-solids capture 128 assembly is located distally from the shorter side wall 142 and adjacent the fluid inlet 114. A lower outer wall 144 is positioned at the base of the capture tray 138.

As can be seen from the Figs, the section of the capture tray 138 connected to and adjacent the micro-solids capture assembly 128 is located lower than side wall 142, resulting in the lower outer wall 144 being provided at an angle to the horizontal.

The two water jets 132 are suspended above the capture screen 130 at a first end 146. A spray bar 148 both supplies and provides a mounting point for the two water jets 132. It will be appreciated by the skilled addressee that the location and number of spray jets 132 may be varied. The spray jets 132 are spade or flat fan jets.

The spray bar 148 is provided across the capture screen with both of the jets 132 extending from the spray bar 148 and being angled toward the capture screen plane 136.

The jets 132 are provided at an angle of between 10 and 45° to the capture screen plane 136. In the present embodiment, this is set at 30°.

A micro-solids capture assembly body 150 is used to mount the various components of the micro-solids capture assembly 128. The assembly body 150 also defines the micro-solids entry port 134. The micro-solids entry port 134 is provided adjacent a second end 52 of the capture screen 130. The first 146 and second ends 152 are on distal edges of the capture screen 130. A simple spray bar valve 149 is located on the spray bar 148 outside the assembly body 150 to enable fluid control.

The capture screen 130 is a generally wire mesh screen type; more specifically the capture screen 130 is a wire wedge screen type. However, the skilled addressee will appreciate that alternative forms of filter media may be employed.

The capture screen 130 may for certain applications have a filter size of generally between 100 and 900 μm, although in the present embodiment the capture screen 130 has a filter size of 500 μm.

As can be seen from the various Figs, the jets 132 are orientated generally towards the second end 152 of the capture screen 130 and the micro-solids entry port 134.

The micro-solids port 134 feeds into and is connected to a micro-solids collection assembly 154.

The micro-solids collection assembly 154 comprises a collection chute 156 which attaches directly to the micro-solids collection port 134 and a micro-solids feed tube 158, the latter being joined to the former, and there being defined therein a flow path between the too. A screw conveyor (not shown) is located within the feed tube 158.

A micro-solids flanged water outlet pipe 160 extends from the micro-solids assembly body 150, generally perpendicular to the main axis X-X of the compressor 36.

The compressor 36 includes a non-return valve 162 at the fluid outlet 116. The fluid outlet 16 comprises a flanged outlet pipe 164 within which sits the non-return valve 162.

The non-return valve 162 includes a valve shuttle 166. The valve shuttle 166 is generally cylindrical in form, and may slide to a limited extent within the flanged outlet pipe 164.

The valve shuttle 168 comprises an initial plug section 168a, generally in the form of a flattened ellipsoid or disc portion 168a, from which extends a frusto-conical connecting section 168b, which joins at its apex to a larger frusto-conical inlet portion 168c, and onto the main cylindrical section 168d. Seal indentations 68e, 68f are located adjacent the junction between the frusto-conical connecting section 168b and the main cylindrical section 168d, and at the distal extent of the main cylindrical section 168b. Suitable o-ring seals (not shown) are placed within these seal indentation 168e, 168f.

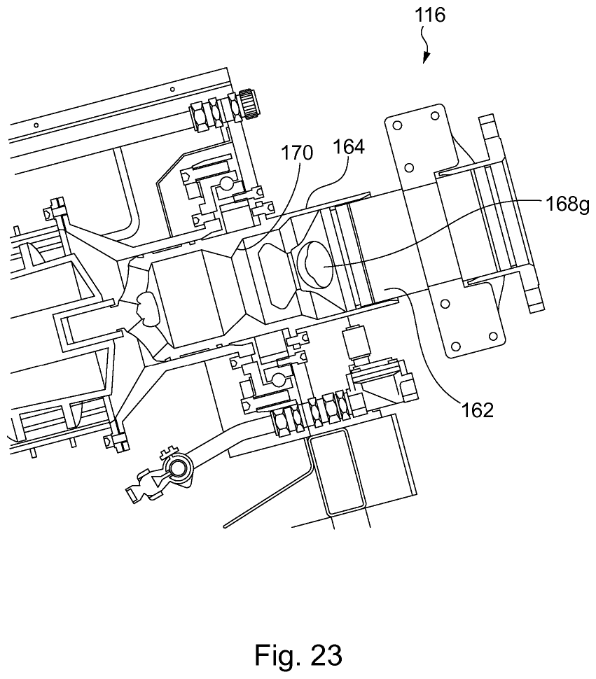

The frusto-conical connecting section 168b and the main cylindrical section 168d are hollow and allow material to pass through them when the valve is in the open position (see FIG. 23). Four or more apertures 168g are provided on the frusto-conical connecting section 168b to enable a fluid pathway to form into the interior of the main cylindrical section 168f.

A valve seat 170 is provided within the flanged outlet pipe 164, which at its narrowest point is narrower than the greatest diameter of the disc portion 168a. The valve seat 170 prevents the valve shuttle 166 from moving too far towards the screw shaft 120.

A valve control yoke 172 is provided round the approximate mid-portion of the valve shuttle 168 via a collar attachment groove 174 provided around the valve shuttle 68 on the main cylindrical section 68d. Pneumatic actuators 176 are connected to the control yoke 172 to enable control over the amount of travel and the resistance to travel of the valve shuttle 168, thereby enabling control over back-pressure within the compressor 36.

The central shaft 122 of the screw shaft 120 has a non-uniform diameter along its length, and is split into two discrete sections: an initial uniform section 122a and a second, non-uniform section 122b. The non-uniform section 122b has a first outer diameter at a first end (which is equal in diameter to the initial uniform section 122a) and a second outer diameter at a second end, wherein the second diameter is greater than the first diameter.

The screw shaft 120 is an auger-type screw.

The non-uniform section 122b increases in diameter from the first outer diameter to the second outer diameter in a linear fashion, albeit it will be appreciated by the skilled addressee that the non-uniform section 122b may increase in diameter from the first outer diameter to the second outer diameter in a non-linear fashion, such as a step change, a multi-step change, a parabolic change, etc. Furthermore, the diameter may be non-uniform along the entire length i.e. the non-uniform section accounts for up to 100% of the length of the shaft. In the present embodiment, the uniform section 122a accounts for approximately 33% of the total length, although this may be varied in alternative embodiments.

The second section 122b therefore has a generally frusto-conical shape.

The flights 124a of the helical screw 124 has an outer diameter that remains constant over the entire length of the screw shaft 120 i.e. it forms a generally uniform cylindrical outer shape along its entire length.

This constant outer diameter is achieved by a decrease in the extent by which the helical screw 124 projects from the non-uniform section of the screw shaft 120.

The helical screw 124 has a constant pitch in the present embodiment, although that may be different in alternative embodiments without departing from the scope of the present invention.

The helical screw 124 may have different pitches on the non-uniform and uniform sections.

A constant torque Variable Frequency Drive (VFD) motor 175 and gearbox 177 is provided to rotate the screw shaft 120. A screw shaft geared slew ring 179 is driven by the VFD motor 175. The slew ring 179 to drive gear ratio is in the region of 6:1 to 5:1 in the present embodiment, which reduces the required torque from the motor 175.

In the present embodiment the auger screw shaft 120 is a right hand helix, meaning that it is driven clockwise (from the vantagepoint of the fluid inlet 114) in use.

The rotational speed of the screw shaft 120 is fully variable such that the volumetric flow rate may be varied and optimised. The highest rotational speed will be typically around 20 RPM for most applications, but will preferably be around 5 RPM. Rotational speed may be varied beyond this level.

An alternative embodiment screw shaft is shown in FIG. 27, generally referred to as “320”. Analogous technical features are numbered similarly, save for a prefix “3”.

The screw shaft 320 is also an auger type, but this has variable pitch helical screw section 324a, wherein the distance between subsequent flights narrow progressively over the length of the non-uniform section 322b. There may be some direct proportional relationship between the distance between subsequent flights 324a and the increase in diameter of the second section 322b.

The rotational direction of the screw shaft is reversable. This may help with the clearance of blockages.

A filter 126 is provided around the fluid cavity 118 and screw shaft 120. The filter 126 is cylindrical and forms a close fit around the flights of the screw shaft 120. The outermost edges of the flights may be provided with a coating or may be treated to minimise friction or minimise the gap between the outermost edge of the helical screw 124 and the filter 126.

The filter 126 in the present embodiment is rotatable, and contra-rotates with respect to the screw shaft 120.

The change in diameter across the non-uniform section 122b of the central shaft 122 results in the flow area (i.e. the annular area between the outer diameter of the central shaft 122 and the inner diameter of the filter 126) being reduced by between 80 and 90%. In the present embodiment, this is achieved by use of a central shaft 122 having a uniform section diameter of 100 mm (also being the initial diameter of the non-uniform section 122b) increasing to a maximum diameter of around 450 mm.

The filter 126 comprises three individual screen sections 126a, 126b, 126c in the present embodiment, although this may be replaced with more or fewer individual sections, and may comprise simply a uniform screen section across the entire length.

The screen sections 126a, 126b, 126c in the present embodiment are wire screens, more specifically wedge wire screens.

The screens comprise a lower screen 126a, an upper screen 126c and a centre screen 126b.

The screens 126a, 126b, 126c may have a filter size of between 50 and 500 μm in typical applications, with the lower screen 126a typically having the largest filter size. The lower screen 126a may have a filter size of between 200 and 300 μm, but in the present embodiment has a specific filter size of 250 μm.

The centre screen 126b may have a filter size of between 100 and 200 μm, but in the present embodiment the centre screen has a filter size of 175 μm.

The upper screen 126c may have a filter size of between 50 and 150 μm, but in the present embodiment the upper screen 126c has a filter size of 100 μm.

The filter 126 is rotatably mounted at either end of the fluid cavity 118, on an inlet-side hub 178 adjacent the fluid inlet 114 and on an outlet-side hub 180 adjacent the fluid outlet 118.

The inlet-side hub 178 has rotational motion imparted through it whereas the outlet-side hub 180 is free-rotating or “slave” hub. The inlet-side hub 178 is a generally disc-shaped hub mounted on a suitable bearing 182. A geared slew ring 183 attaches to the inlet-side hub 178.

The outlet-side hub 180 has a more complex shape than its distal counterpart. The outlet-side hub 180 comprises an attachment flange 184 which mechanically attaches to the filter 126, a frusto-conical hub section 86 attaching to the flange 184, from which extends a cylindrical boss section 188, the latter surrounding the initial inboard portion of the outlet pipe 164. Rotational rod seals are provided between the boss section 88 and the outlet pipe 164. A gasket 92 is provided between the filter 126 and the attachment flange 184.

A constant torque Variable Frequency Drive (VFD) motor 194 and gearbox 196 is provided to rotate the filter 126 which drives the filter slew ring 183. The slew ring 183 to drive gear ratio is in the region of 6:1 to 5:1 in the present embodiment, which reduces the required torque from the motor 194.

A support frame 200 mounts the compressor body 12. The support frame 200 comprises an upper support frame 216 which is directly connected to and supports the compressor body 112, a lower stand 218 which contacts the surface upon which the compressor body 112 is to be mounted, first and second support stanchions 220,222 which are provided with pivot pins 224, the stanchions connecting the lower stand 218 to the upper support frame 214 adjacent the inlet pipe 114, and an adjustable support frame 226, which connects the lower stand 118 to the upper support frame 214 adjacent the outlet pipe 116.

The adjustable support frame 226 is connected to the upper support frame 214 via pin and lug arrangements 228 at their uppermost portions.

A variable sliding support mechanism 230 mounts the adjustable support frame 226 to the lower support frame 218. The variable sliding support mechanism 230 enables the relative position of the join between the adjustable support frame 226 to the lower support frame 218 to be varied such that the angle of adjustable support frame 226 to the lower support frame 218 may be varied, thereby varying the angle of the upper support frame 216 to the horizontal and increasing the relative angle of the compressor body 112.

As can be seen from the Figs, the frame 200 allows the compressor body 112 to be maintained at an angle of around 15 degrees in the present embodiment. Moreover, this angle may be varied using the variable sliding support mechanism 230.

The compressor 36 having both the inlet flanged pipe and outlet flanged pipe is colloquially “hard-piped” into the apparatus i.e. it can sustain an internal pressure without risk of the contents leaking or being exposed to the atmosphere, all of which is beneficial in such processes for obvious reasons.

Material being processed enters the fluid chamber 118 and is drawn along it under the action of the screw shaft. This forces the animal slurry against the filter 126 compressing it and allowing the liquid fraction of the slurry to pass through the filter 126 and falls into the capture tray 138. Such water may include micro-solids and the capture tray water jet flushes the water and entrapped micro-solids towards micro-solids capture assembly 128.

As the water/micro-solids land on the screen 130, part of the water is further filtered by the screen 130 and falls into and may be pumped away via the water outlet pipe 164. This may then be further filtered as required.

Micro-solids in a slightly drier form fall into the micro-solids port 134, through the chute portion 154 and are then transported through the pipe 158 via the screw compressor.

Whilst these may be transported anywhere, in the present embodiment these are fed back into the top of the macerator/hopper unit 16 to be fed back through the process.

The animal slurry as it travels up the screw shaft is progressively compressed as the diameter of the non-uniform portion 122b begins to increase. As the slurry is generally confined between successive augur flights, this increase in diameter causes a proportional reduction in volume for the slurry, and a greater outward pressure is exerted on the slurry, causing further dewatering in combination with the reduction in filter media size as it travels along the three screens 126a, 126b and 126c.

The slurry is then driven by the screw shaft 120 towards the non-return valve 162. The force of the slurry acting on the initial plug section 68a causes the valve shuttle to travel away from the centre of the compressor 36 thereby opening the valve and allowing the now drier slurry to move through the valve and onto the next process stage. As the valve shuttle is biased into a closed position, this creates an additional back pressure on the slurry which may aid in further dewatering the animal slurry.

The slightly drier, flocculated matrix M is then fed along compressor pipe 138 to the thermal desorption unit 120.

Thermal desorption unit 20 comprises a generally sigmoidal pipe assembly 42 in turn comprising three generally horizontal sections 42a, 42b, 42c or “generators”; with progressive horizontal sections being connected by two curved pipe sections 44 (connecting upper horizontal section 42a and middle horizontal section 42b) and 45 (connecting middle horizontal section 42b and lower horizontal section 42c). Each of the two curved pipe sections 44, 45 forms a 180° path to reverse the flow of the matrix. The two curved pipe sections 44, 45 are each formed from two 90° curved sections.

The horizontal and curved sections are joined by flanges. Augers 46a, 46b, and 46c are provided respectively within each horizontal section 42a, 42b and 42c, the augers being powered by respective electric motors 48a, 48b and 48c.

The augers 46a, 46b, 46c aid in propelling the matrix M along each horizontal sections 42a, 42b, 42c. The augers 46a, 46b, 46c are variable pitch augers.

Three heating coils 50a, 50b, 50c surround, respectively, the outer surfaces of the horizontal section 42a, 42b and 42c. Thermal insulating jackets 52a, 52b, 52c surround, respectively, the heating coils 50a, 50b, 50c and the corresponding horizontal section 42a, 42b and 42c.

The heating coils 50a, 50b, 50c in the present embodiment are induction heating elements. The heating coils 50a, 50b, 50c raise the temperature within the generator from the ambient temperature to a temperature above that and further dry the matrix M. The applied heat serves to pasteurise the contents of the desorption unit 20.

An induction heating control unit 54 with associated supply/control lines 56, 58 is provided to operate the induction heating coils.

A condensate tank 60, which includes a tube shell heat exchanger, receives evaporate from several points on the thermal desorption unit 20 via evaporate supply lines 62.

This evaporate may include water, but also other volatile chemicals. As well as purely “evaporated” water, more water is drawn off in the form of atomised water droplets.

Ultrasound transducers 64 are provided on the outer surface of the thermal desorption unit 20 at various points, including attached around the junctions between each of the two curved pipe sections 44, 45 and the corresponding horizontal sections 42a, 42b, 42c. The ultrasound transducers 64 are attached as radially focussed inward, in-line ad around the circumference of the pipe sections. Additional transducers (not shown) may be provided along the base of one or more of the horizontal sections focussed upwards and inwards i.e. towards the area where the matrix M is present in use.

The number of transducers 64 at each section in the present embodiment is four, however this number may be increased or decreased depending on pipe size. The ultrasound transducers 64 are intended to:
1. Break up any plugs of matrix M that may form ensuring continued flow;
2. Impart energy into the liquid phase of the matrix M though heavy cavitation, this may reduce energy requirements at the thermal desorption stage by up to 5%;
3. Power ultrasonic frequencies are applied; 20 to 100 kHz, however typically 20 to 40 kHz. The frequency is modulated to optimally:
   a. Cavitate the liquid fraction and impart energy into the liquid and dissolved matter molecules;
   b. Cause resonance in the structural body of the ironwork ensuring that no scale can build up and that plugs Are prevented from forming;
   c. Typical power draw per transducer is 150=/<1000 Watts (although this may reach as much as 4000 Watts, depending on application).

Further ultrasound transducers may be provided at various points along the process lines, especially on the pipework, to undertake similar functions as described above.

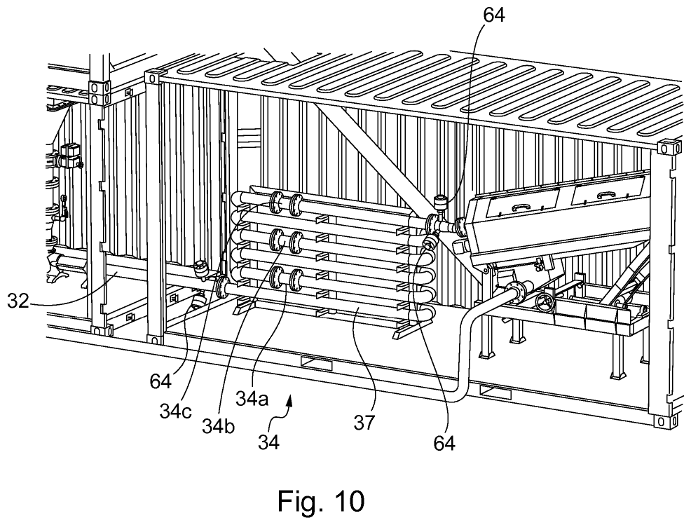

As can be seen from FIG. 10, additional ultrasound transducers 64 are provided on the hopper exit pipe 32 adjacent its junction with the input to the flocculation system 34, and also adjacent the junction between the flocculation system 34 and the mechanical compressor/dewatering system 36, and along the compressor pipe 38, prior to entry into the desorption unit 20.

A nitrogen supply system 66 is provided which feeds nitrogen to the bases of the first, second and third horizontal sections 42a, 42b, 42c. Nitrogen is injected via a plurality of jets at the bases first, second and third horizontal sections 42a, 42b, 42c and provide a gaseous fluidised bed continually churning the matrix M, atomise an additional portion of the liquid phase of the matrix M (thereby reducing energy input required to evaporate the liquid fraction) and provide an inert atmosphere inside the thermal desorption unit 20. The plurality of jets may be simply spaced along the length of the first, second and third horizontal sections 42a, 42b, 42c in a linear fashion, or may be deployed in a grid, or in any other suitable way.

A non-return valve 68 is provided at the termination of the last horizontal section 42c which serves to maintain a sealed environment within the thermal desorption unit 20, providing a material output to the system.

An output conveyor belt 70 is provided adjacent the non-return valve 68. In the present embodiment, the apparatus 10 is being used to produce growth media, and given that the moisture content is around 30-35% (too low for pelletisation), the output conveyor belt 70 may be used to transport the output product (growth media) for bagging/storage prior to use. If fertiliser production is to be achieved, it will be appreciated that the moisture content should stay around 45%, the resultant output product would then ideally be pelletised prior to further drying in pellet form.

Water drawn off the Matrix M from both the mechanical compressor 18 and the thermal desorption unit 20 (from tank 60) is fed via pipes to spent water tank 22. The water is allowed to cool to an acceptable temperature (the water being drawn of the mechanical compressor 18 at largely ambient temperature whilst a more elevated temperature may be apparent from the thermal desorption unit 20).

The water in the tank 22 will also contain potentially undesirable volatiles and so forth, coming mainly from the desorption unit 20.

The water in tank 22 is then transported by pump 72 to the filtration assembly 24 via pipes 74. The water enters individual filtration units 26 via a lower entry manifold 26a.

Filtration unit 26 is a tank filled with a filter matrix 26b (in this embodiment of a type described in PCT/GB2008/003308) in the lower portion of the tank interior (albeit taking up a majority of the headspace of the unit).

A geotextile layer 26c covers the filter matrix 26b. A layer of aggregate 26d covers the geotextile layer 26c. These layers substantially remove organic and inorganic contaminants, resulting in relatively contaminant free water filling the headspace 26e of the filtration units 26, which may be removed via upper pipe/spigot 26f, using further pipes 76 and pump 78. Such water may be used for irrigation, drinking, washing and so forth.

A second embodiment waste product method and apparatus 410 are depicted in FIG. 6. These are largely similar to the first embodiment method and apparatus 10 described above.

Apparatus 410 comprises three discrete sections: a feed skid 410a (the left hand side of FIG. 6); a generator skid 410b (the centre portion of FIG. 6); and a treatment skid 410c (the right hand side of FIG. 6).

The feed skid 410a comprises a hopper/macerator unit 418 into which the matrix M may be fed. The present embodiment will be fed with a positive displacement pump (not shown). This positive displacement pump (not shown) will not intrude on the induction heated portion of the system but the feed will be transported via pipework (not shown).

Slurry matrices M will either be pre-homogenised or (dependant on slurry type) the pump itself will have in built macerators etc for this purpose. There may be feed-back loops from the condensate end to provide additional moisture for the feed if necessary. A progressive cavity pump (not shown) may be employed because of their versatility; however the important thing to note is that it is a positive displacement pump which therefore provides a pressure seal. This allows a vacuum to be applied to the system greatly reducing the boiling point of processed liquids.

A chemical feed inlet line 412 feeds into the upper portion of the hopper/macerator unit 418, and which may be used to deliver additional chemicals to the matrix M to enable such chemicals to be present in the output product. This may be used to improve fertiliser quality for example.

The second embodiment may be used for agricultural slurry, so in the present embodiment a phosphate silo 414 and a sulphate silo 416 are provided, which both feed into the chemical feed inlet line 412. The skilled addressee will appreciate that these may employ separate feed lines, and indeed further or alternative silos/chemicals may be employed.

A bund and sump pump assembly 415 is provided on a first end of the chemical feed line 412, and this enables the contents of the silos to be administered to the hopper 418.

The matrix M, having passed through hopper 418 and potentially having phosphates/sulphates added as required, is forced along pipe 420 by first pump 422. First pump 422 in the present embodiment is a Progressive Cavity Pump.

Pipe 420 in the present embodiment is low pressure Chiksan® hose, but suitable alternatives may be used. The pipe 420 marks the nominal beginning of the Generator Skid portion of the apparatus.

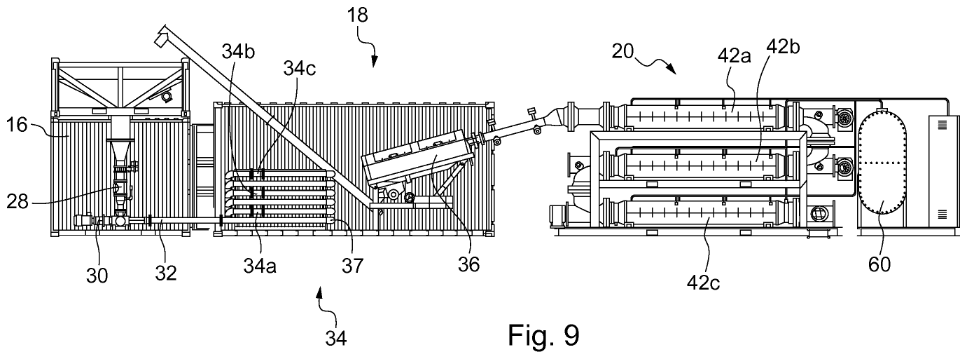

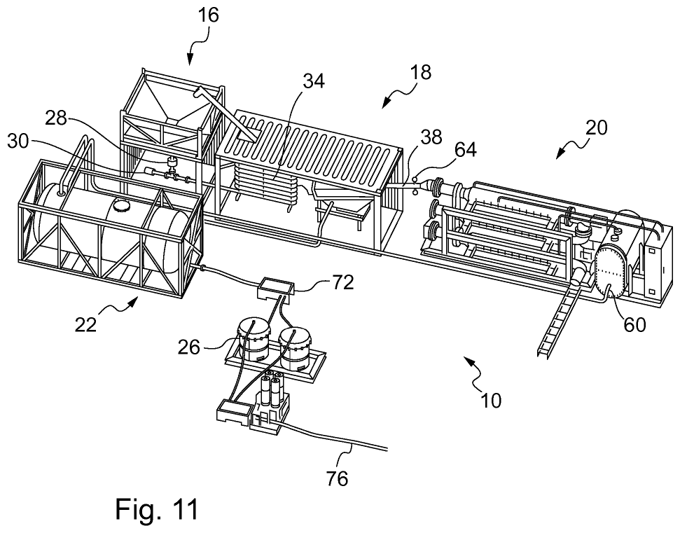

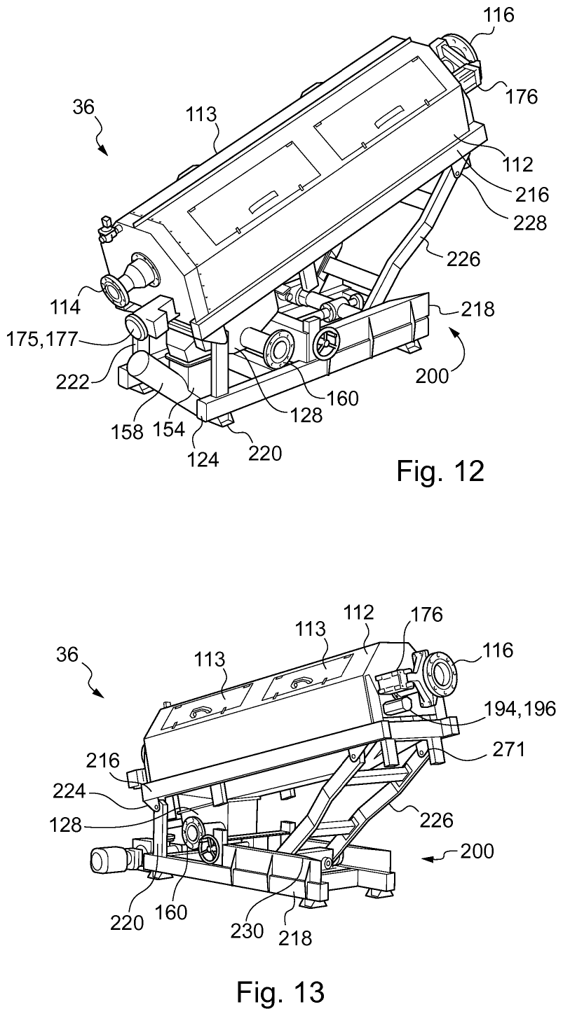

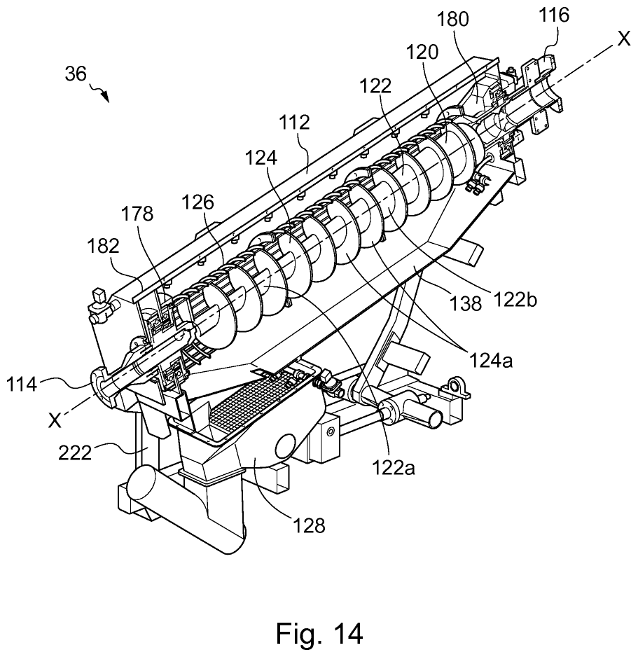

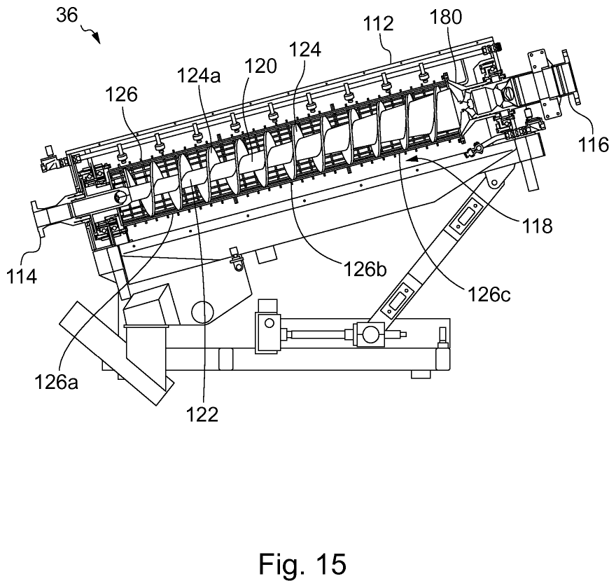

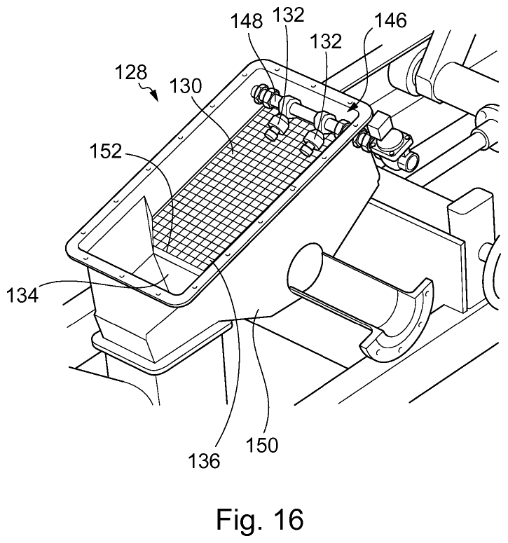

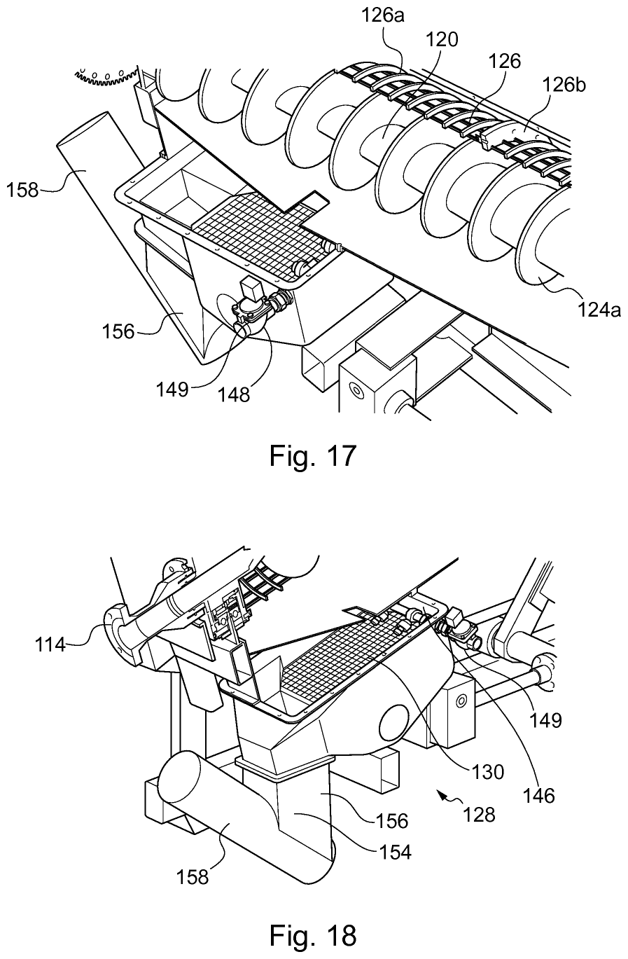

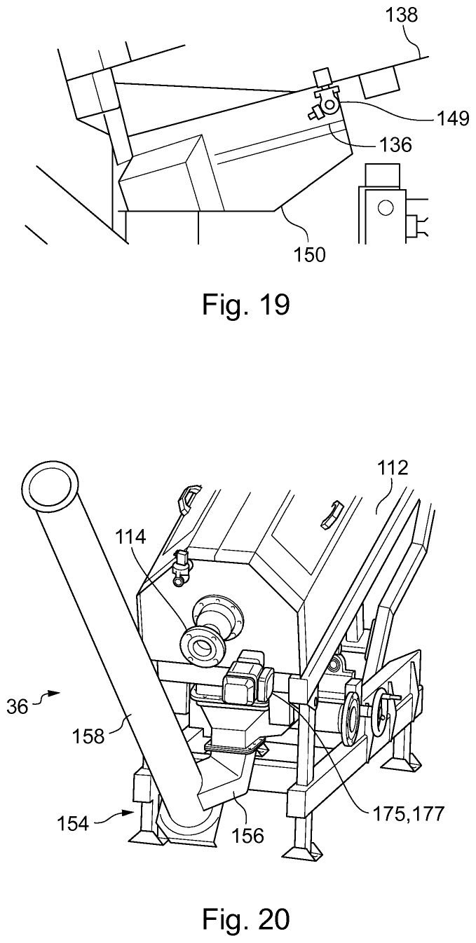

A first generator 424 attaches to the distal end of pipe 420. The first generator 424 is shown in more detail in FIGS. 8 to 21.

The first generator 424 comprises a central tube section 424a, surrounded by an outer sleeve 424b. The outer sleeve 424b is slightly shorter than the central tube section length 424a, thereby exposing part of the tube section 424a at each extremity.

A cavity 424c is defined between the sleeve 424b and a heating coil 425 is located within the cavity 424c. A first flange 424d is located at the first end of the first generator 424 to enable attachment with pipe 420 and a second flange 424e is located at the second end of the first generator 424 to enable attachment as will subsequently be described. Coolant inlet 427 and outlet ports 429 are located at either end of the sleeve 424b, and these supply a water jacket (not shown) to enable temperature regulation of the heated internals of the generator.

A nitrogen inlet nipple 424f is located on the central tube section 424a between the first flange 424d and sleeve 424b. The nitrogen inlet nipple 424f is located on the underside of the generator when in situ.

A ferromagnetic heating element 424g is located within the body of the central tube section 424a. The ferromagnetic heating element 424g comprises a tubular outer body 424h within which two helical screws 424i are formed, creating a generally helical fluid path through the generator 424. This increases the surface area from which heat may be applied to the transiting matrix M as it is forced through the generator 424 by virtue of the action of the pump 422. The inner surface of the ferromagnetic heating element 424g and the helical screws 424i are coated with a high temp ceramic non-stick coating, such as Duraceram® coating. The ferromagnetic heating element 424g is induction heated by the heating coil 425.

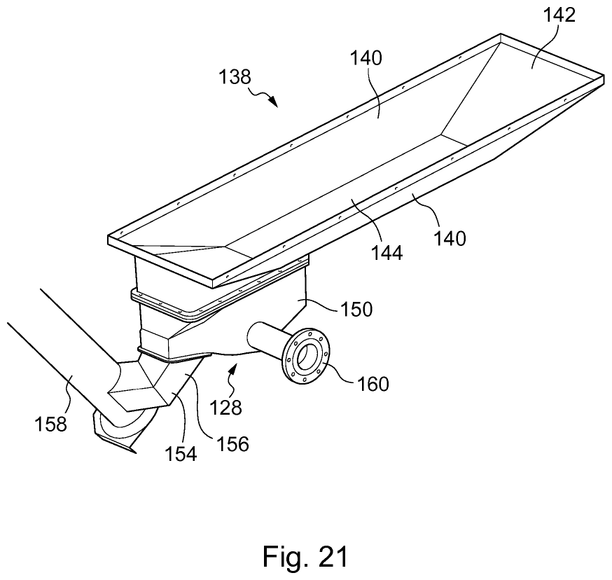

The underside of the ferromagnetic heating element 424g has a plurality of channels 424j formed into it in a rectangular criss-cross pattern as can be best seen in FIG. 21. Small bores 424k are provided at the junctions of the channels 424j. The plurality of channels 424j and bores 424k are in fluid communication with the nitrogen inlet nipple 424f.

An inert gas (in this embodiment nitrogen, although other inert gases are possible) supply system 470 is provided which feeds nitrogen to the first, second and third generators. The nitrogen supply system comprises a nitrogen generator 472 which feeds into an accumulator 474, and subsequently into a nitrogen supply line 476. Two, parallel redundant pressure regulators 478 are provided between the accumulator 474 and the nitrogen supply line 476.

The nitrogen supply line 476 attaches to the nitrogen inlet nipple 424f. Nitrogen flows into the plurality of channels 424j and out through the bores 424k, creating a plurality of nitrogen jets into the lowermost portion of the ferromagnetic heating element 424g. This creates a gaseous fluidised bed which agitates the matrix M increasing the surface area exposed to heat but also causing a portion of the entrained liquid within the matrix M to vaporise rather than evaporate.

A vapour outlet nipple 424h is located on the central tube section 424a between the sleeve 424b and the second flange 424d and allows fluid flow out of the centre of the generator as will subsequently be described. The vapour outlet nipple 424h is located on the top of the generator 424 when in situ.

A vacuum assembly 479 is attached via vapour supply lines 480 to the vapour outlet nipple 424h, and analogous nipples on the subsequent generators as will subsequently be described.

The vacuum assembly 479 comprises two parallel vacuum condensers 484, with a vacuum pump 486 creating the necessary vacuum pressure. The vacuum pump 486 may be further connected to chemical scrubbers or filters depending on the composition of the vapour/gas drawn off the vacuum condensers.

Since a positive displacement pump is used, it therefore provides a pressure seal. This assists the vacuum on the system significantly reducing the boiling point of processed liquids within matrix M. Evaporate and vapour drawn off are then condensed in vacuum condensers 484.

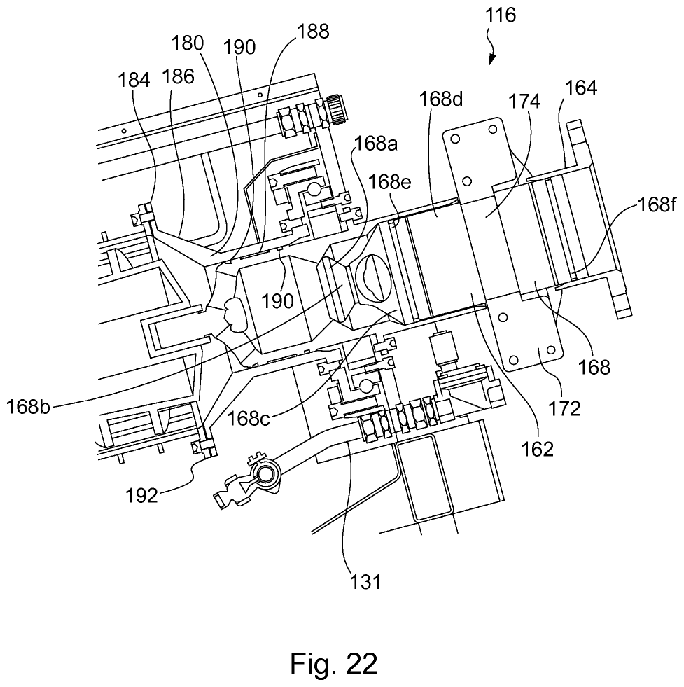

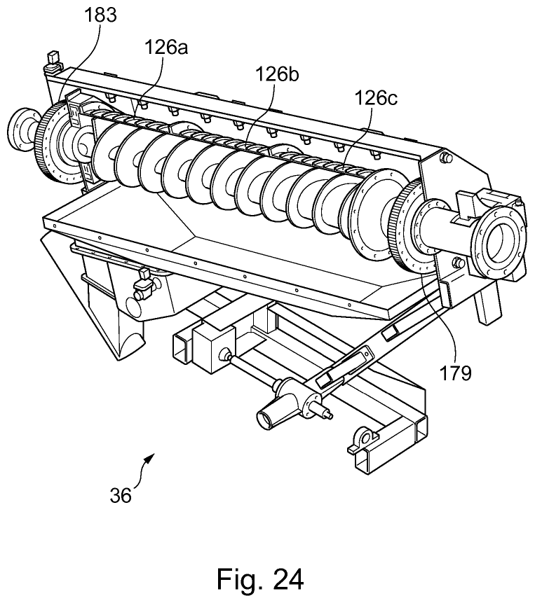

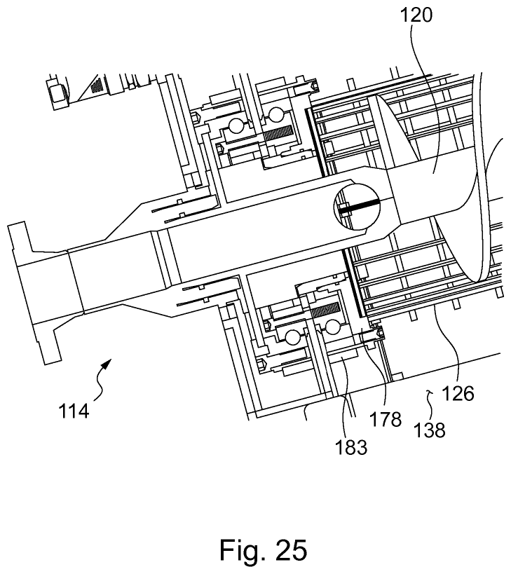

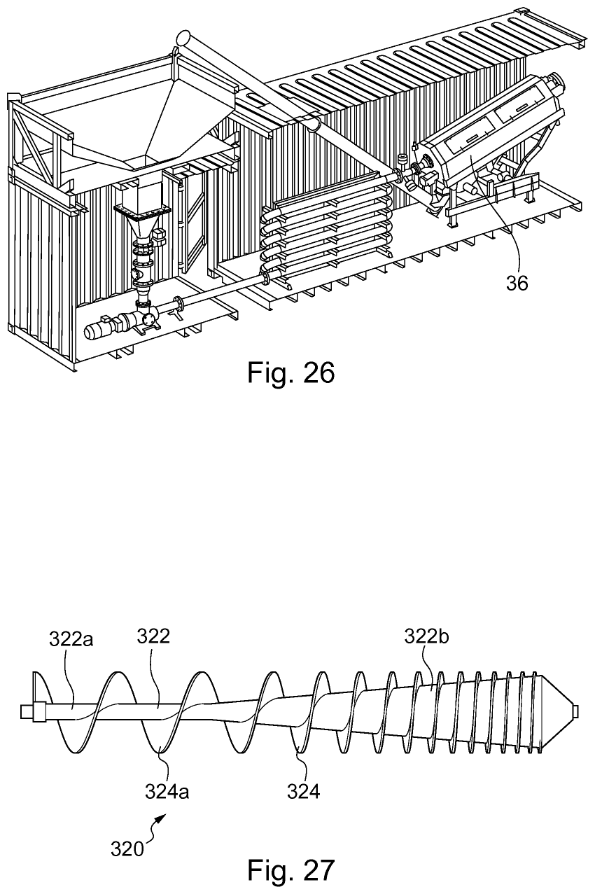

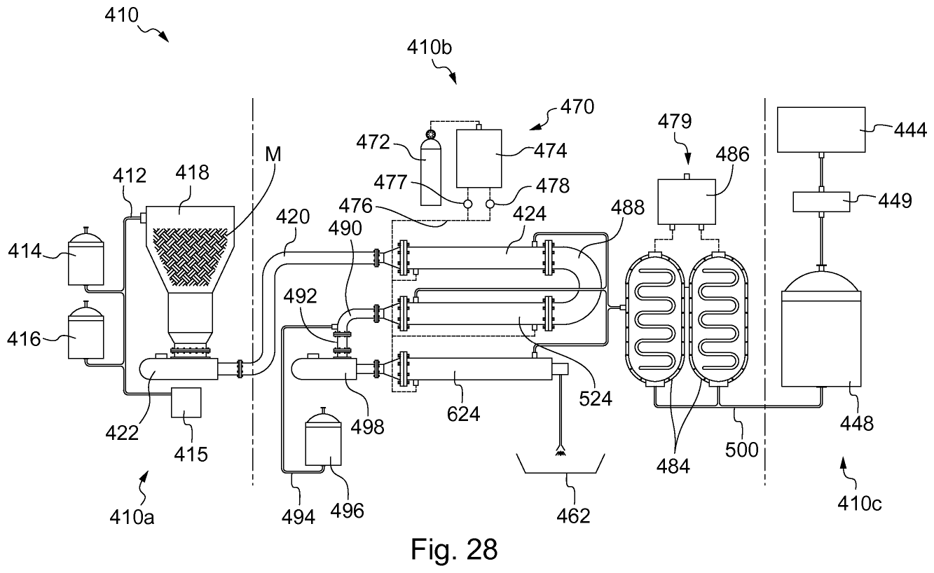

A second generator 524 is attached to the first generator 424 by a simple U-bend pipe 488. The second generator 524 is quite similar to first generator 424 and analogous components use the same lettering scheme as used above e.g. the central tube section is 524a, the sleeve is 524b and so forth. FIGS. 22 to 29 show the second generator 524 in greater detail.

The main difference is that the ferromagnetic heating element 524g is a simple tube, and there are no helical blade inserts.

As liquid is drawn off the matrix M in the first generator, the matrix M becomes less fluid and thus the relatively smooth bore of the second generator 524 aids the flow of matrix M.

As with the first generator 424, a gaseous nitrogen bed is applied to the lower portion of the generator interior, with vapour being drawn off under vacuum.

It is important to note that the first two generator sections take advantage of heat recovery via convection as they are opening connected in series.

A third pipe 490 connects the second generator 524 to a vertical macerator 492. By this stage the matrix M may be even less fluid and be relatively dry, and the vertical macerator 492 homogenises the matrix M.

A second chemical feed inlet line 494 feeds into the lower portion of the third pipe 490 just prior to vertical macerator 492, and which may be used to deliver additional chemicals to the matrix M to enable such chemicals to be present in the output product. A nitrate silo 496 supplies feed line 494.

A second pump 498 (also in the present embodiment a Progressive Cavity Pump) receives matrix M from the vertical macerator 492.

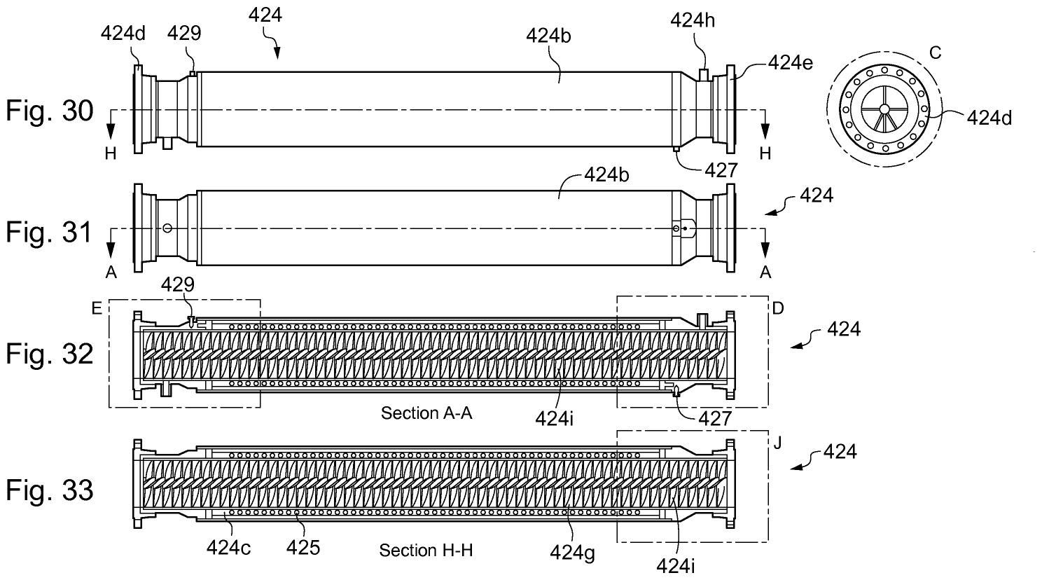

A third generator 624 is attached to the second pump 498. The third generator 624 is quite similar to both the first 424 and second generators 524 and analogous components use the same lettering scheme as used above e.g. the central tube section is 624a, the sleeve is 624b and so forth. FIGS. 30 to 37 show the third generator 624 in greater detail.

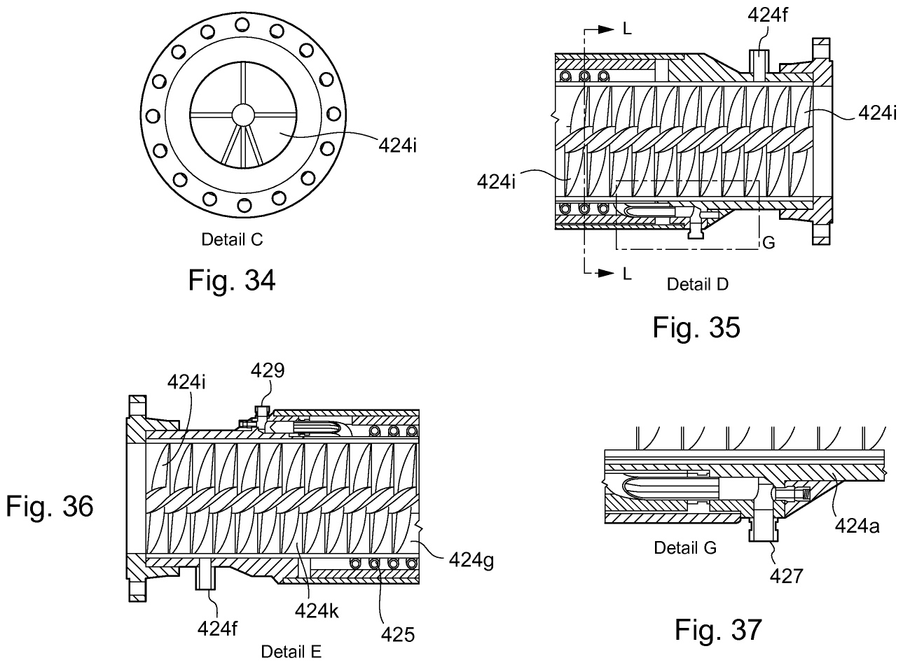

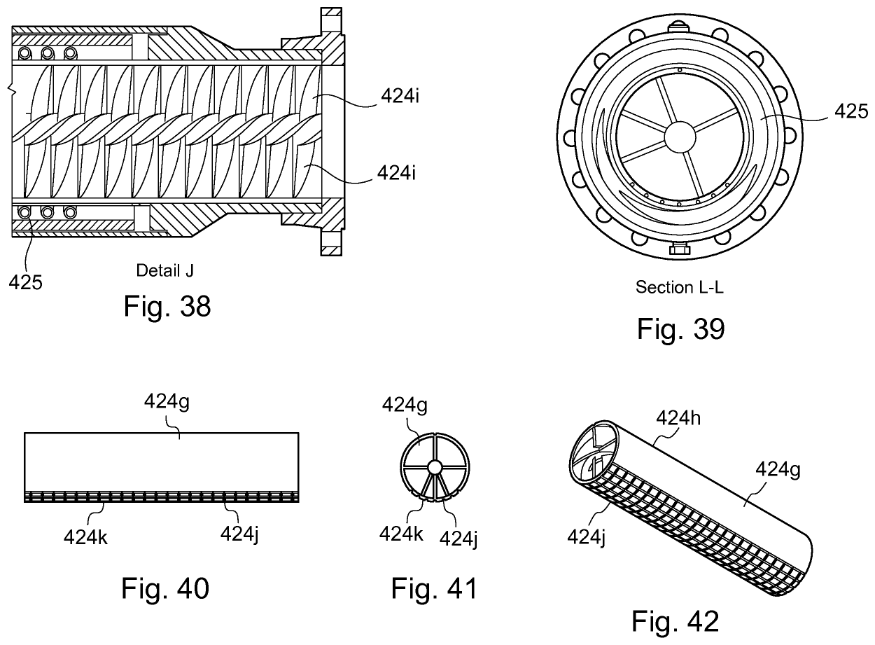

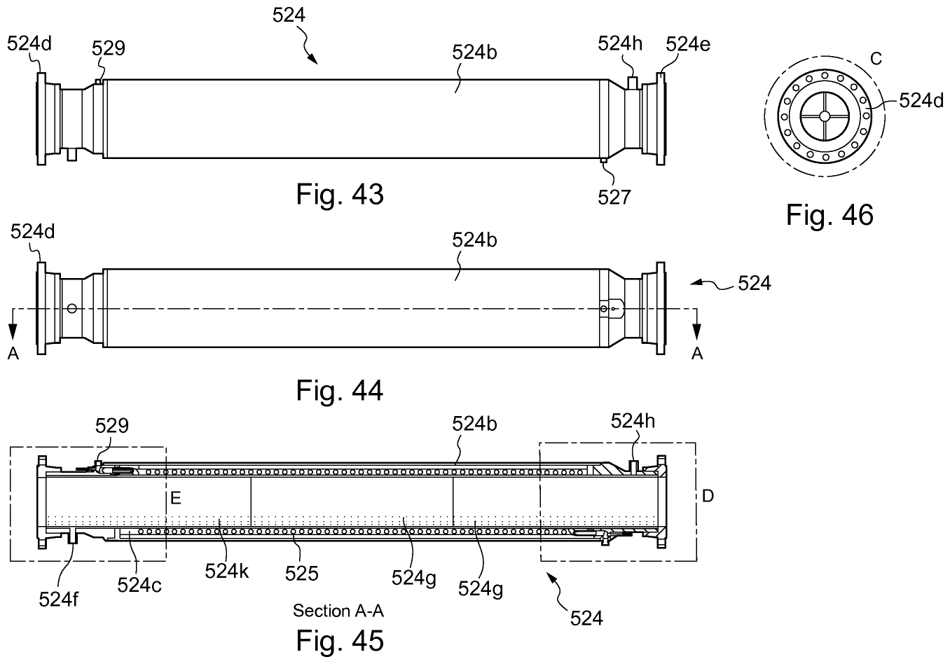

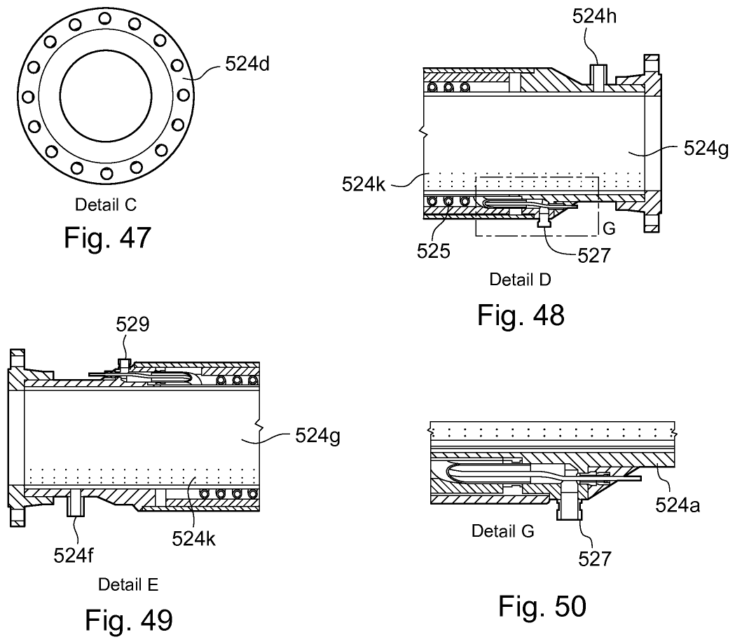

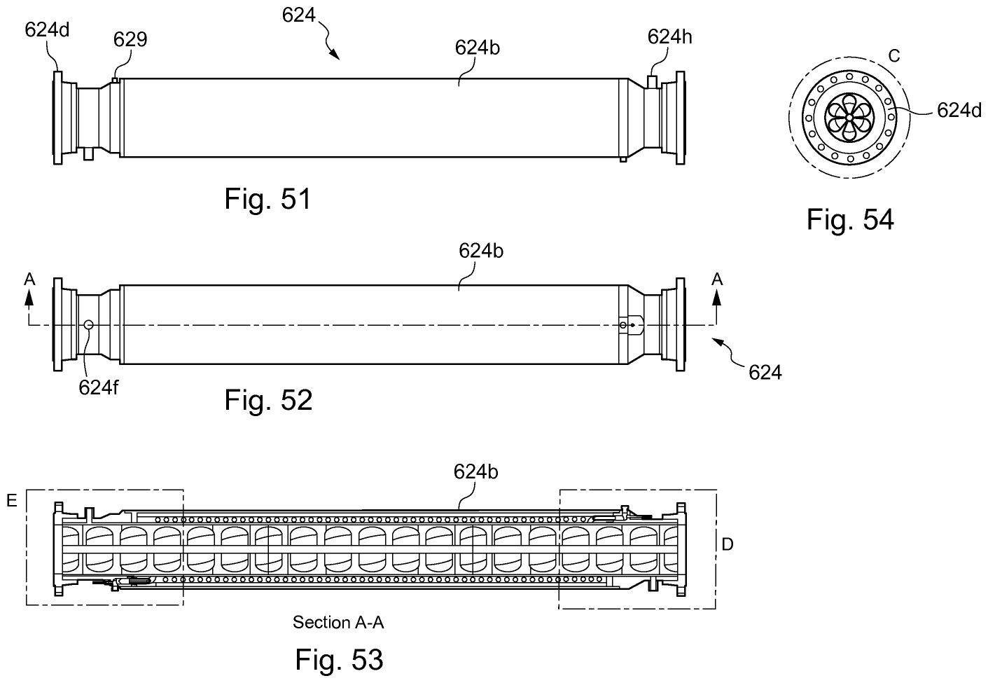

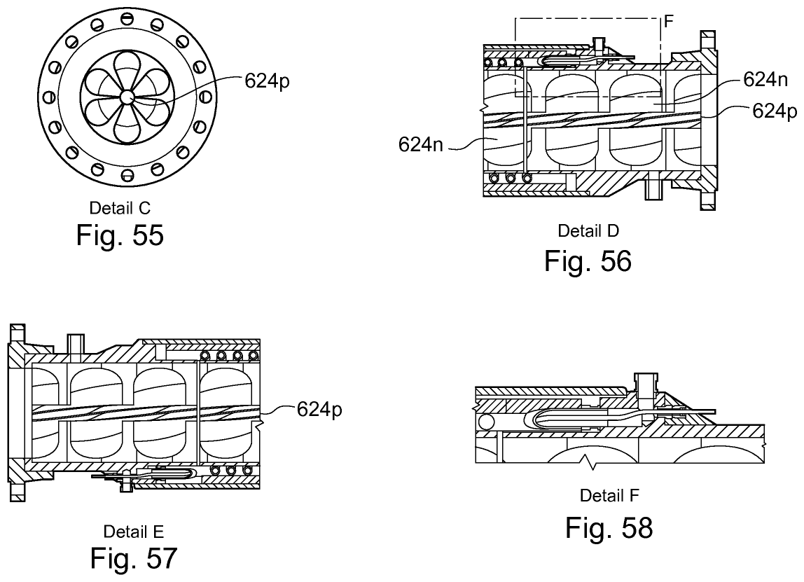

The main difference is that the ferromagnetic heating element 624g does have helical lobes provided within it, as well as being split into a plurality of discrete sub-chambers 624n. As can be seen from FIG. 34, the initial cross-section is of a hexafoil i.e. a six-lobed flower-like shape, and this shape is rotates about its central axis along the central axis of the ferromagnetic heating element 624g. A central, narrower bore 624p is provided along the length of the ferromagnetic heating element 624g, which connects each of the discrete sub-chambers 624n. The central, narrower bore 624p is formed with a greater helix pitch.

The second pump 498 drives the matrix M through the third generator, which incorporates fixed helical mixing profile inserts (i.e. the sub-chambers), against a die/pelletizer. Solids/pellets are collected on a conveyor for cooling and skipped or bagged. This final stage will be full ‘pipe flow’ (due to material being forced through a die) and also incorporates nitrogen inflow and vacuum draw. It is this final stage that may be used for the production of bio-char and syngas in some applications.

The liquid which condenses in the vacuum condensers 484 is drained into a liquid feed line 500 and is transported to the Treatment Skid portion of the apparatus.

The treatment skid comprises a primary filtration unit 448 which contains further sorbent A. Liquid enters the filtration unit 448 at the bottom and passes through layers of the further sorbent A. The liquid then passes to a second filter unit 449 before being collected in a condensate tank 444. With agricultural slurry the liquid will be water and, depending on the filtration efficiency, may be safe for environmental disposal, agricultural use or may even be potable.

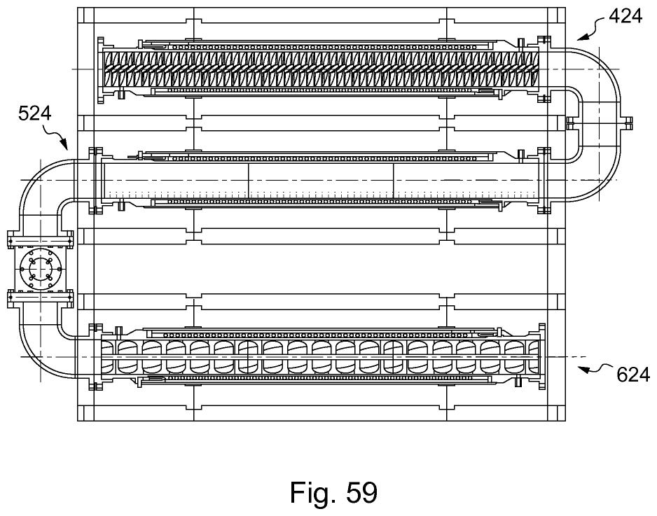

FIG. 59 is a side sectional elevation of the three generators 424, 524 and 624. It will be appreciated that the three generators 424, 524 and 624 described may be used with the first embodiment 10 and vice versa.

It will be appreciated by the skilled addressee that, depending on application, the exact type, sequence and number of generators may be varied. For example, a first and third generator may be used without an intervening second generator, or a second and third, and so forth. Moreover, the helical profiles of the various described elements within the generators may be altered, both in terms of such properties as pitch/chirality, but may also be altered to non-helical geometries.

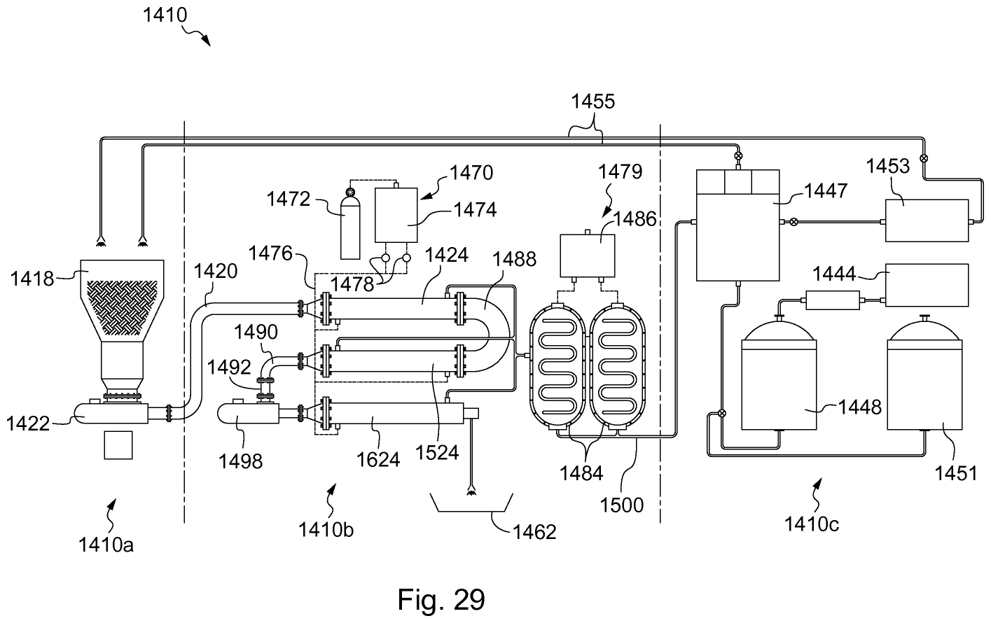

A third embodiment waste product method and apparatus 1410 are depicted in FIG. 29. These are very similar to the second embodiment method and apparatus 410 described above, and very similar or identical components are identified using the same numbering scheme as above, albeit prefixed with a “1”, except as described below.

The third embodiment 1410 is envisaged to handle oil sludges, hydrocarbon mixtures and so forth, but may be suitable to treat other fluid/liquid/semi-fluid materials.

The feed and generator skids are largely identical to the second embodiment, albeit that the chemical silos are omitted entirely.

The treatment skid 1410c is more appreciably different. The treatment skid 1410c of the third embodiment comprises firstly a dissolved air flotation unit 1447. This separates the condensed liquid into water which flows out of the bottom of the unit 1447 and through pipework to a primary filtration unit 1448 which contains further sorbent A. Liquid enters the filtration unit 1448 at the bottom and passes through layers of the further sorbent A. The liquid then passes to a second filter unit 1449 before being collected in a condensate tank 1444.

An optional secondary filtration unit 1451 is provided in parallel to the primary unit, which also contains further sorbent A. Liquid enters the filtration unit 1448 at the bottom and passes through layers of the further sorbent A.

Hydrocarbon or otherwise oily sludge is pumped to a sludge tank 1453 or taken directly from the dissolved air flotation unit 1447. These are then re-routed back to the hopper/macerator for further processing by pipework 1455.

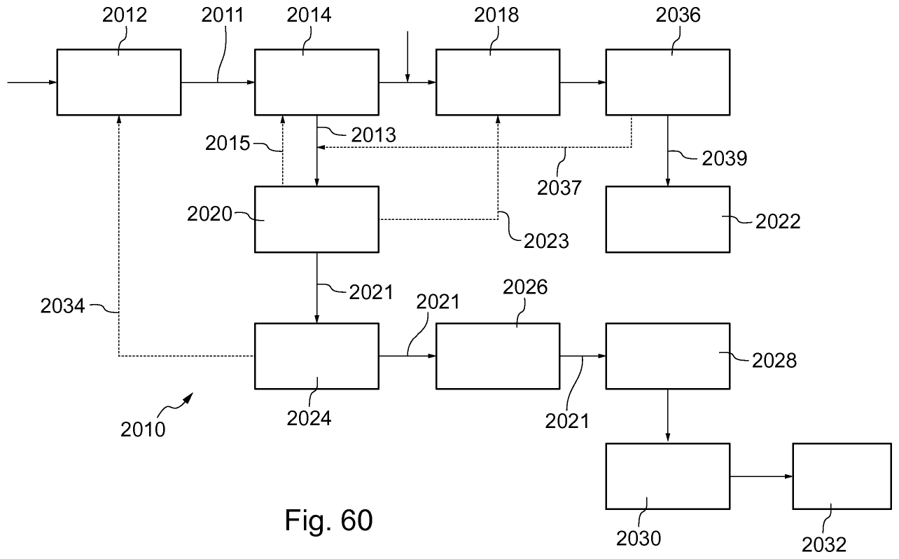

It will be noted that the dewatering compressor has been omitted from the Figs representing the second and third embodiments, although such a compressor may be placed prior to the thermal desorption unit FIG. 60 depicts in schematic form a fourth embodiment of the present invention generally referred to as 2010. The fourth embodiment may find particular application with human sewage, albeit as with the other embodiments alternative materials may be processed with it.

Apparatus 2010 comprises a raw effluent holding tank 2012, in which draff is added to the effluent. The effluent draff mixture 2011 is transported to a Dissolved Air Flotation (“DAF”) process 2014, which flocculates and partially dewaters the effluent/draff matrix by floating solid matter to the surface and skimming it off. This replaces the flocculating unit 34 of the first embodiment apparatus 10.

The partially dewatered effluent/draff matrix (a thickened “sludge”) passes into a balance tank 2018 then onto a dewatering compressor 2036 (equivalent or exactly as the compressor 36 described above) for further dewatering. The removed water 2013, 2037 from the DAF 2014 and compressor 2036 stages passes into a biological treatment process 2020.

Waste activated sludge 2015 from the process 2020 may then be passed back into the Dissolved Air Flotation process 2014, and sediment 2023 passed from the biological treatment process 2020 to the balance tank 2020.

The dewatered sludge 2039 exiting the dewatering compressor 2036 is passed into a solids disposal process 2022.

Liquid water 2021 exits the biological treatment process 2020 and is transported to a primary filter unit 2024, then onto a second balance tank 2026, then to a disinfection and trace element removal process 2028, a secondary filter unit 2030, before finally arriving at a storage tank 2032. The water by this stage may be usable for certain purposes, or may be further processed to reach potable standards. Primary and secondary filter units 2024, 2030 are in this embodiment sand filter units with automatic backwash. A backwash water return 2034 connects the primary filter unit to the storage tank 2012.

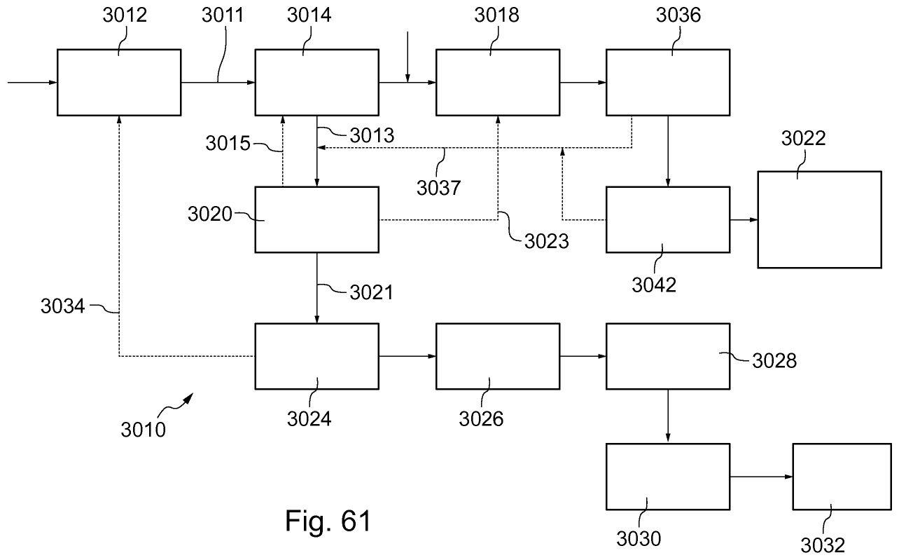

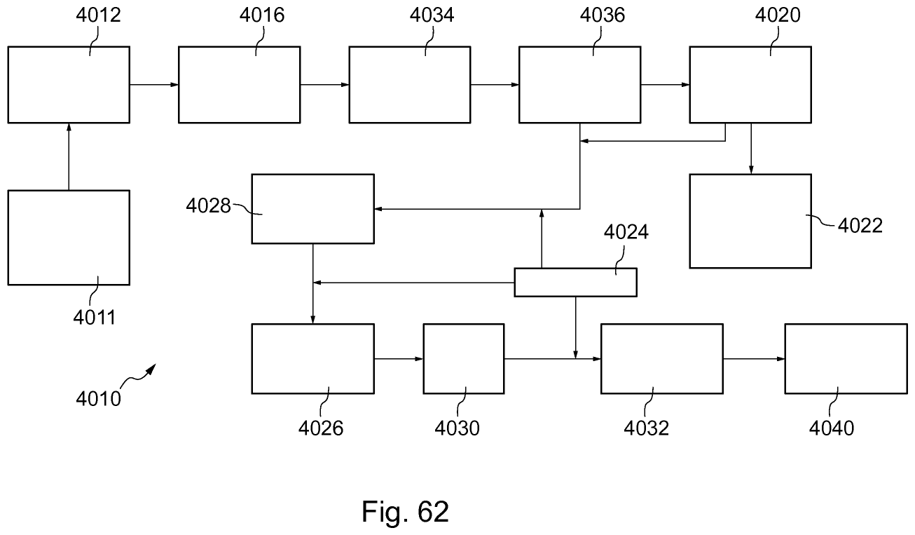

FIG. 61 depicts in schematic form a fifth embodiment of the present invention generally referred to as 3010. The fifth embodiment again may find particular application with human sewage, albeit as with the other embodiments alternative materials may be processed with it. The numbering scheme of the fifth embodiment is similar to that of the fourth embodiment, albeit with the “30” prefix replacing the “20” prefix.

The main difference is the inclusion of a thermal desorption unit 3042 (which may be equivalent to the first embodiment's unit 20 or the second embodiment's unit 424, 524, 624). This serves to both further dry and pasteurise the treated material. Water 3043 from the thermal desorption unit may then be mixed with the water 3037 from the compressor stage 3036 before entering process 3020 (or indeed fed separately into process stage 3020).

FIG. 61 depicts in schematic form a sixth embodiment of the present invention generally referred to as 4010. The sixth embodiment again may find particular application with human sewage, albeit as with the other embodiments alternative materials may be processed with it.

Apparatus/process 4010 is largely similar to the first embodiment, comprising an effluent/draff mixing tank 4012, which feeds into a hopper/macerator unit 4016, feeding into a flocculating unit 4034, then into a dewatering compressor 4036, onto a thermal desorption unit 4020 and finally to a pasteurised solid output 4022.

Three PCP pumps 4024 are used to move the material around the system, per previous embodiments (especially apparatus 10).

Water from the mechanical compressor 4020 and/or the thermal desorption 4020 stage is fed into a first balance tank 4028, and onto a draff filled filter 4026 (as per the filter unit 26 of the first embodiment).

The water exiting the draff filter unit 4026 is fed into a second balance tank 4030, and onto a secondary filter unit 4032. This may be also a draff filter unit, but in the present embodiment is a sand filter/AOP unit. Finally, the water is reused/stored at 4040, which may be a tank or simply a feed to another process.

Previously digestate was mixed with draff and fed directly into the hopper/macerator 16 feed skid.

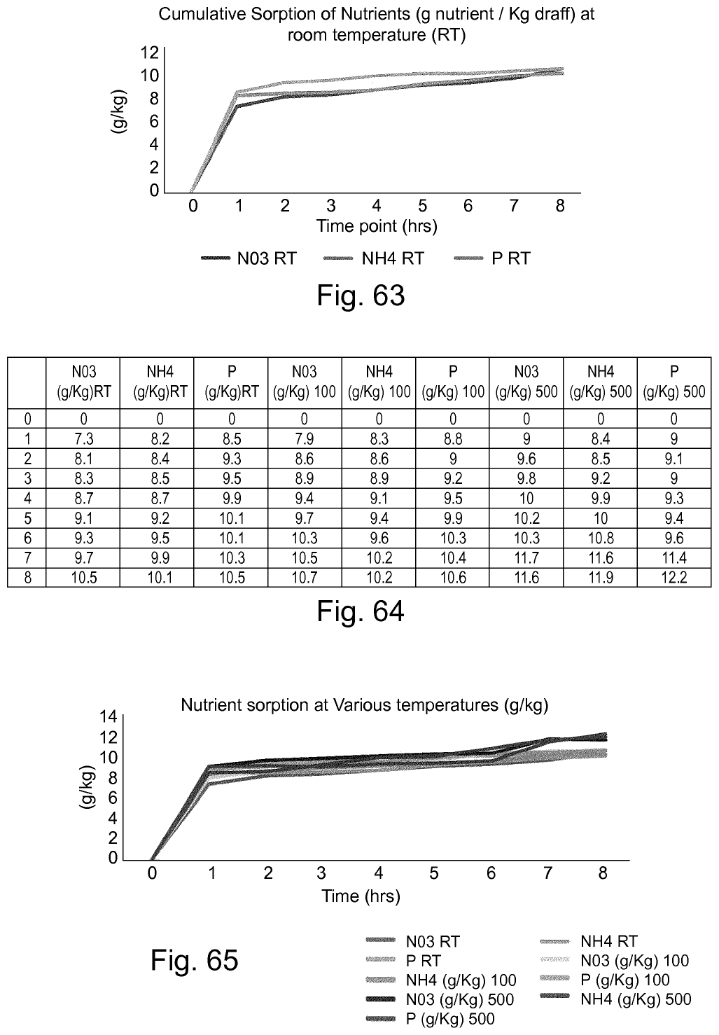

Laboratory test data is shown in graphical and tabular form in FIGS. 63, 64 and 65.

Laboratory experiments utilised 10 mg/L, 20 mg/L and 100 mg/L nutrient (NO3, NH4 and P) concentrations within a batch system. Initial set up was replicated in triplicate and each vessel was intended to replicate an industrial throughput of between 1-10m3 effluent per hour at a range of temperatures. Batches were run over a range from 100 to 500° C.

The derived standard saturation curves at room temperature for NO3, NH4 and P are shown in FIG. 63.

Standard saturation curves were constructed for the sequestration of nutrients from contaminated liquids such as sewage, leachate and AD digestate by draff at various concentrations and temperatures.

From the resultant saturation curves Kd values (solid/liquid partitioning ratios or dissociation coefficients) were determined for each nutrient. The time taken for the draff to reach saturation was also noted.

Dissociation coefficients (Kd) are calculated using the formula below where A is sorbed fraction and C is dissolved fraction (i.e. the ratio of nutrient sorbed to nutrient remaining dissolved in the liquid phase after saturation).

From the data obtained and displayed in the table of FIG. 64, draff sorbs between 10 and 13 g of all the nutrients analysed. This equates to a Kd value of between 5000 and 6000 for all nutrients. This is high and would be equitable to peat.

Observation of the data displayed in FIG. 64 suggests that whilst there is no statistical significance between measured temperatures and Kd, it can be observed that not only is maximum sorption achieved more rapidly but also that slightly more nutrient is sorbed and bound to the draff as the temperature increases.

In effect this suggests that nutrient capture onto the DRAM filter matrix (draff) can be marginally enhanced by incremental temperature increases.

Additional testing has shown that the likely sorption mechanism of nutrients to draff is in fact adsorption rather than absorption. This means that the molecular species accumulates at the surface of the draff particles rather than being ‘soaked-up’ like a sponge.

### Summary of Conclusions

Draff sorbs between 10 and 13 g of all the nutrients analysed per kg draff at saturation
Draff reaches approximately 80% saturation with respect to sorption of nutrients within 1 hour
Draff reaches saturation in 8-10 hours
Increase in temperature marginally decreases saturation time and increases saturation nutrient level
Sorption mechanism is adsorption not absorption

An additional stage is now included.

1. Digestate is pumped into a heated reactor vessel 4011 and brought up to a temperature above ambient. The reactor vessel may include means for agitating the contents.
a. Temperature of reactor vessel 4011 will typically be no higher than 100° C. (as temperature effects are marginal in terms of increased sorption and superheating the digestate at this stage poses undesirable health and safety risk).
   2. Draff is added at a predetermined ratio w/w digestate
a. The amount of draff required is easily discernible from the kd value if the nutrient content of the digestate is known from laboratory testing.
b. Additional draff may be added if increased lignin content or cation exchange ability if advantageous.
c. The total volume in the reactor vessel is matched to the desired hourly volumetric process rate.
   3. The draff/digestate matrix is allowed to soak at temperature for 1 hour.
a. The time is determined from the laboratory data above
80% saturation is typically achieved in one hour
   4. The draff/digestate matrix is then pumped to the post-nutrient transfer buffer tank 4012, where it is fed directly into macerator/PCP feed skid
a. Assuming the raw digestate was pre-screened for unwanted objects this connection can be hard piped rather than hopper fed—thus fully enclosed
   5. As soon as the reactor vessel is empty, fresh raw digestate is fed in and the above process repeats

The observation that the sorption mechanism is absorption rather than absorption means that sorbed nutrients are far less likely to be lost back to the liquid phase during the mechanical dewatering phase of the process and should therefore remain with the valuable dry matter.

The observation that sorption of nutrients at elevated temperatures decreases saturation time and increases saturation nutrient level will also have a positive effect during the thermal desorption stage 4020 of the system.

As slurry enters the thermal desorption stage 4020 of the system it will have a water content of ˜ 60-70%. Some nutrients will still be dissolved in the liquid fraction. Thus, as the slurry matrix is heated, sorption of nutrients into the entrained draff will continue at an accelerated rate even while water is evaporated off. This effectively will help to ensure maximum transfer of nutrients to the dry matter (solid) fraction as the material is pasteurised.

The skilled addressee will appreciate that the invention is not limited to the embodiment hereinbefore described, but may be modified in construction and/or detail.

For example, further inlets or outlets may be disposed along the length of the generator to enable specific fractions or chemicals to either be drawn off or fed into the process.

Although a whisky-based draff is discussed above as the sorbent, other suitable sorbents may be employed, such as draff from brewing process or other waste-products or by-products from agricultural processes or otherwise.

High temperature rated ultrasonic transducers or atomizers may be employed across all or only some of the generator sections 424, 524, 624. These will serve to vaporise entrained liquid rather than evaporate, further decreasing energy input into the system.

The use of mechanical dewatering, ultrasound and the nitrogen fluidised bed aid in the dewatering of the matrix M as it flows through the desorption unit, and therefore reduces the thermal energy required.

For example:
1. 1 m\hat{ }3; 92% water slurry@1SG=920 kg water
2. Dewatered to 65% water=148.57 kg water

Typically, for fertiliser production, slurry cannot be dewatered lower than ˜ 45% water by weight or pelletisation becomes impossible (material will not bind).

Typically for growth media production, target water content will be 30-35% water by weight. The growth media is then simply vacuum bagged; taking growth media with a target water content of 35%:
1. Dewatered mechanically to 65% water=148.57 kg water
2. Thermally dewatered from 65 to 35% water=43.08 kg water
3. Water to be evaporated by thermal energy alone=105.49 kg

Power to heat water volumes from 20 to 100 C @ atm pressure in one hour:
1. 920-43.08=877 kg=˜3674 kJ/hr
2. 105.49 kg=˜442 kJ/hr

Power to evaporate water volumes at atm pressure in one hour:
1. 877 kg water in 1 hr=1980 MJ/hr
2. 105.49 kg water in 1 hr˜=238 MJ/hr

Power to heat and evaporate water volumes in one hour:
1. 877 kg water in 1 hr˜=1984 MJ/hr=551 kJ/s (kW)
2. 105.49 kg water in 1 hr˜=283 MJ/hr=78.61 kJ/s (kW)

Thus, in this scenario, a 500 kW thermal evaporation system could produce the following amounts of DM growth media per hour respectively:
1. 92% water slurry=69 kg growth media
2. Mechanically dewatered slurry @ 65% water=509 kg growth media Therefore a theoretical 86.4% increase in DM productivity.

The invention is not limited to the embodiments hereinbefore described, but may be varied in construction and detail.

It will be apparent to the skilled addressee that the various components of the various embodiments are interchangeable to produce new embodiments. Moreover, additional process stages (such as further mechanical compressing, flocculation and/or thermal desorption) may be added at various points along the previously described apparatus/methods.

1. A method of treating a waste product comprising the steps of adding a sorbent to the waste product to form a fluid matrix, the matrix being then subjected to a compressive force to remove a fraction of liquid from the matrix to form a dryer matrix.

2. A method of treating a waste product according to claim 1 further including the step of applying heat to the matrix to remove a further fraction of liquid from the matrix and to pasteurise the matrix.

3. A method of treating a waste product according to claim 2 wherein the step of applying heat to the matrix is done after the application of the compressive force.

4. A method of treating a waste product according to claim 1 wherein the matrix is flocculated prior to being mechanically compressed.

5. A method of treating a waste product according to claim 1 further comprising the step of applying ultrasound to the matrix.

10. A method of treating a waste product according to claim 5 wherein the ultrasound is applied after the matrix has been mechanically compressed and prior to it being heated.

13. A method of treating a waste product according to claim 1 wherein nutrients are added to the matrix.

14. A method of treating a waste product according to claim 13 wherein the nutrients include one or more from the following group: nitrates, phosphates and potassium.

15. A method of treating a waste product according to claim 1 wherein the temperature of the waste product is increased into the range of 80° C. to 100° C. prior to the addition of the sorbent.

18. A method of treating a waste product according to claim 1 wherein the sorbent is added to the waste product at least one hour prior to the application of the compressive force.

19. Apparatus for treating waste products to which a sorbent has been added to form a matrix, the apparatus comprising a material inlet, a dewatering compressor and a material outlet.

20. Apparatus according to claim 19 further including apparatus for flocculating the matrix.

21. Apparatus according to claim 20 wherein the flocculating apparatus is provided between the material inlet and the dewatering compressor.

22. Apparatus according to claim 19 further including a thermal desorption unit.

23. Apparatus according to claim 22 wherein the thermal desorption unit is located between the dewatering compressor and the material outlet.

24. Apparatus according to claim 22 wherein the desorption unit comprises three sections.

25. Apparatus according to claim 24 wherein at least one of the three sections is provided with an auger.

29. Apparatus according to claim 19 further including one or more ultrasound transducers.

32. Apparatus according to claim 19 further including one or more ultrasound transducers located between the material inlet and the dewatering compressor and/or between the dewatering compressor and the thermal desorption unit.

35. Apparatus according to claim 19 further comprising a heated reaction vessel where the waste product and the sorbent matrix are held prior to entry to the dewatering compressor.
